(19) United States
(12) Patent Application Publication
(10) Pub. No.: US 2006/0168357 A1
(43) Pub. Date: Jul. 27, 2006

(54) Information input/output system

(76) Inventors: Toshihisa Nakano, Neyagawa-shi (JP); Makoto Tatebayashi, Takarazuka-shi (JP); Naoki Yamamoto, Neyagawa-shi (JP); Hideshi Ishihara, Katano-shi (JP)

Correspondence Address: WENDEROTH, LIND & PONACK L.L.P., 2033 K. STREET, NW, SUITE 800, WASHINGTON, DC, 20006, US

(21) Appl. No.: 10/562,816

(22) PCT Filed: Jul. 8, 2004
(86) PCT No.: PCT/JP04/10068

§ 371 Date: Dec. 30, 2005

(30) Foreign Application Priority Data
Jul. 8, 2003 (JP) 2003-271929

(51) Int. Cl. G06F 3/00

(52) U.S. Cl. 710/5; 710/1

(57) ABSTRACT

An input/output (IO) system reduces the processing load involved in judging whether a device is valid or revoked. The system is constituted from an input/output (IO) device and an information usage device. The IO device outputs an identifier (ID) list to the information usage device, the ID list including one or more identifiers (IDs), arranged according to a predetermined rule, that each correspond to a different valid or revoked device. The information usage device uses the received ID list to specify a target range that includes a target ID stored by the information usage device, and outputs range information indicating the specified target range to the IO device, which uses the received range information in judging whether the information usage device is valid or revoked.

### TECHNICAL FIELD

The present invention relates to technology for authentication using public key encryption, and in particular to technology for authentication using a list that identifies valid and/or revoked devices.

### BACKGROUND ART

In recent years, the rapid expansion of the Internet has also resulted in a growth in the number of systems whose communication is based on the Internet. Electronic transaction system for buying and selling goods via the Internet are one such example. In a system whose communication is based on the Internet, it is essential to confirm that the party with whom you are to communicate with is an authorized participant in the system. This is called “authentication”. The party trying to communicate may, for instance, be a person operating a device or a device that performs processing by a predetermined procedure, although for the purposes of this description, “device” is used hereinafter to refer collectively to the communication party in all instances, while the process of authenticating a device is referred to as “device authentication”. Note also that the process of a device demonstrating its authenticity (i.e. that it is an authorized participant in the system) is referred to as “certification”, and that the process of confirming the authenticity of a device is referred to as “validation”. The authentication process encompasses both the certifying by and verifying of a device.

Encryption technology includes common key encryption and public key (PK) encryption. With common key encryption the keys for encrypting and decrypting are the same. With PK encryption, in contrast, the keys for encrypting and decrypting are different. Authentication preferably is carried out using PK encryption. This is because of the fact that in authentication using common key encryption, the verifying party ends up with the same secret as the certifying party, which creates the danger of the verifying party passing themselves off as the certifying party after authentication has been completed. So-called “password” systems are an example of this. In authentication using PK encryption, the certifying party certifies their authenticity using a secret key, and the verifying party verifies the certifying party using a public key that corresponds to the secret key. Since the secret key cannot be created from the public key, it is impossible, after authentication, for the verifying party to pass themselves off as the certifying party.

Note that in PK encryption, processing performed using a secret key is referred to “performing a signature”, and confirming the authenticity of a signature using a corresponding public key is referred to as “verifying a signature”.

Consider the following example of authentication performed using PK encryption: A 1st device transmits random data as challenge data to a 2nd device, which then performs a signature on the random data using its secret key and returns response data to the 1st device, which verifies the received signature using the public key of the 2nd device. Generally, authentication performed using PK encryption is premised on the public key being valid within the system.

For this reason, it is common in such systems for “public-key certificates” that certify the authenticity of public keys corresponding to devices (i.e. guarantees of the authenticity of public keys) to be issued by an organ known as a certificate authority (hereinafter “CA”). A public-key certificate (hereinafter “certificate”) consists of an electronic signature of the CA attached to data that conjoins a validity period, public key and identifier name of a device. A certificate is confirmed as being authentic once a device that receives the certificate has confirmed the authenticity of both the CA's electronic signature and the content of the certificate using the device's ID name, the present time and the like. Furthermore, in order to inform other devices of the certificates of devices deemed to be unauthorized and removed from the system (i.e. revoked certificates), a certificate revocation list (hereinafter “CRL”) is issued that consists of the CA's electronic signature attached to a list of information specifying these certificates as being revoked.

Transacting with unauthorized devices can thus be avoided by performing the above processing to authenticate a device using the public key of the device, having firstly obtained the certificate of the device and confirmed that the obtained certificate is not among the revoked certificates entered in the CRL. Note that since CRLs, in terms of format, actualization and the like, are realizable using arbitrary well-known technology, a detailed description is not included here. An exemplary CRL actualization is disclosed in Reference 1 below, and an exemplary CRL format (data structure) defined by the X.509 standard developed by ISO/IEC/ITU is disclosed in Reference 3 below.

Considered here is a configuration (e.g. personal computer) that includes a reading device (drive) that reads data from disks and a device (host) that controls the reading device and uses read data. The processing capability of the drive is normally lower than that of the host. In judging the authenticity of the host's certificate, it is necessary for the drive to check whether the certificate is listed in a CRL.

However, a problem lies in the fact that the CRL increases in size with increases in the number of certificates entered therein, which increases the processing time needed to check the list, and ultimately the processing load on the normally low processing capability of the drive.

Reference 1: Japanese Published Patent Application No. 2003-115838

Reference 2: Japanese Published Patent Application No. 2002-281013

Reference 3: Warwick FORD, Michael S. BAUM, Secure Electronic Commerce: Building the Infrastructure for Digital Signatures and Encryption, Prentice Hall.

Reference 4: Shinichi IKENO, Kenji KOYAMA, Modern Cryptosystems [gendai angoriron], IEICE.

### DISCLOSURE OF THE INVENTION

To resolve the above problem, the present invention aims to provide an information input/output (IO) system that reduces the processing load involved in judging whether a device is valid or revoked, an input/output (IO) device, an information usage device and a list generation device that are included in the system, an identifier (ID) list, and judging and information specifying methods, computer programs and recording media.

To achieve the above object, the present invention is an information IO system that includes an IO device and an information usage device that performs information input/output via the IO device, the IO device having the information usage device perform part of processing for judging whether the information usage device is one of valid and revoked.

According to this configuration, an IO device in an information IO system reduces the processing load on the IO device involved in judging whether an information usage device is valid or revoked, by having the information usage device perform part of the processing.

Here, the IO device may output an ID list to the information usage device, the ID list including one or more identifiers (IDs), arranged according to a predetermined rule, that each correspond to a different valid or revoked device, the information usage device, as part of the judgment processing, may use the received ID list in specifying a target range that includes a target identifier (ID) stored by the information usage device, and output range information indicating the specified target range to the IO device, and the IO device may receive the range information from the information usage device, and uses the received range information in judging whether the information usage device is valid or revoked.

According to this configuration, the information usage device is able, as part of the judgment processing, to specify a target range using an ID list received from the IO device and to output range information that indicates the specified range to the IO device, and the IO device is able to judge whether the information usage device is valid or revoked using the range information received from the information usage device. As a result, the IO device is, unlike the prior art, no longer required to check the entire content of the ID list, thus lightening the processing load on the IO device in judging whether another device (in this case, the information usage device) is valid or revoked.

Here, the IO device may include: an acquiring unit operable to acquire the ID list from an external source; an output unit operable to output the acquired ID list to the information usage device; an ID receiving unit operable to receive from the information usage device, the target ID and, as the range information, one or more IDs from the ID list that are included within the target range; and a judging unit operable to judge whether the information usage device is valid or revoked, depending on whether the received target ID matches any of the IDs received as the range information, and to suppress the information input/output if the information usage device is judged to be revoked. Furthermore, the information usage device may include: a storage unit operable to store the target ID, which corresponds to the information usage device; a receiving unit operable to receive the ID list from the IO device; an extracting unit operable to use the received ID list in specifying the target range, and to extract all of the IDs included within the specified target range from the ID list; and a data output unit operable to output to the IO device the target ID and the one or more IDs extracted as the range information.

According to this configuration, the IO device receives from the information usage device a target ID and one or more IDs extracted from the ID list, and assesses the validity of the information usage device by judging whether the target ID matches any of the one or more extracted IDs. As a result, the IO device is, unlike the prior art, no longer required to check the entire content of the ID list, thus lightening the processing load on the IO device in judging whether another device is valid or revoked.

Here, the extracting unit may specify the target range from one or more ranges each defined by two IDs arranged consecutively in the ID list, and extract the two IDs defining the specified target range, the data output unit may output to the IO device the target ID and the two IDs extracted as the range information, the ID receiving unit may receive from the information usage device the target ID and the two IDs extracted as the range information, and the judging unit may judge whether the information usage device is valid or revoked, depending on whether the target ID matches either of the two extracted IDs.

According to this configuration, the IO device is able to determine the validity of the information usage device by judging whether the target ID matches either of two IDs that define the target range (note that here “the two IDs defining a range” is used to refer to the IDs at the head and tail of a range).

Here, the target ID may identify a public-key certificate (hereinafter, simply “certificate”) certifying the authenticity of a public key of the information usage device, each ID in the ID list may identify a certificate of a different revoked device, the extracting unit may extract in the arranged order, the one or more IDs included within the specified target range, and the judging unit may judge the information usage device to be revoked if the target ID matches any of the one or more extracted IDs, and valid if the target ID does not match any of the one or more extracted IDs.

According to this configuration, the IO device is able to determine the validity of the information usage device using an ID showing the public key of the information usage device and IDs showing the certificates of revoked devices.

Here, the ID list may have arranged therein according to the predetermined rule, certification data that certifies, with respect to each of one or more ranges, the authenticity of the one or more IDs included within the range, the extracting unit may extract from the ID list, the certification data certifying the authenticity of the one or more extracted IDs, the data output unit may output the extracted certification data to the IO device, the ID receiving unit may receive the extracted certification data from the information usage device, and the judging unit may verify the authenticity of the received certification data, and judge, if the authenticity is verified, whether the information usage device is valid or revoked.

According to this configuration, the IO device additionally receives certification data relating to extracted IDs from the information usage device, verifies the authenticity of the certification data, and is able to judge whether the information usage device is valid or revoked if the authenticity is verified.

Here, the target ID may identify a certificate certifying the authenticity of a public key of the information usage device, each ID in the ID list may identify a certificate of a different valid device, the extracting unit may judge whether any of the IDs in the ID list match the target ID, and extract the matching ID if judged in the affirmative, and the judging unit may judge the information usage device to be valid if the target and extracted IDs match.

According to this configuration, the IO device judges the information usage device to be valid if the target ID matches an extracted ID received from the information usage device.

Here, the ID list may have arranged therein one or more pieces of certification data, each corresponded to and certifying the authenticity of a different one of the IDs, the extracting unit may extract the certification data corresponding to the extracted ID, the data output unit may output the extracted certification data to the IO device, the ID receiving unit may receive the extracted certification data from the information usage device, and the judging unit may verify the authenticity of the received certification data, and judge, if the authenticity is verified, whether the information usage device is valid or revoked.

According to this configuration, the IO device additionally receives certification data relating to extracted IDs from the information usage device, verifies the authenticity of the certification data, and is able to judge whether the information usage device is valid or revoked if the authenticity is verified.

Here, the IO device may further include an information output unit operable to securely output usage information to the information usage device, if the information usage device is judged to be valid, and the information usage device may further includes a usage unit operable to securely receive the usage information from the IO device and use the received usage information.

According to this configuration, the IO device is able to output usage information to the information usage device and the information usage device is able to receive the usage information if the IO device judges the information usage device to be a valid device.

Here, the IO device may further include an ID storage unit operable to store a certificate identifier (ID) that identifies a certificate certifying the authenticity of a public key of the IO device; and an ID output unit operable to output the certificate ID to the information usage device, and the information usage device may further include an ID reception unit operable to receive the certificate ID from the IO device; a list receiving unit operable to receive a revocation list via the IO device, the revocation list including one or more revoked IDs that each identify a certificate of a different revoked device; and an ID judging unit operable to judge whether the IO device is valid or revoked, depending on whether the received certificate ID matches any of the revoked IDs included in the revocation list.

According to this configuration, the information usage device is able to judge whether the IO device is valid or revoked.

Here, the IO device may further include a 1st processing unit operable to establish a secure communication channel between the IO device and the information usage device, if the information usage device is judged to be valid; and an information output unit operable to securely output usage information to the information usage device, if the secure communication channel is established, and the information usage device may further include a 2nd processing unit operable to establish a secure communication channel between the information usage device and the IO device, if the IO device is judged to be valid; and a usage unit operable to securely receive the usage information from the IO device if the secure communication channel is established, and to use the received usage information.

According to this configuration, the IO device is able to output usage information to the information usage device and the information usage device is able to receive the usage information if a secure communication channel is established between the IO and information usage devices.

Here, the information IO system may further include a recording medium storing the ID list, and the acquiring unit may acquire the ID list from the recording medium.

According to this configuration, the IO device is able to acquire the ID list from a recording medium.

Here, the information IO system may further include a communication medium operable to receive the ID list, and the acquiring unit may acquire the ID list from the communication medium.

According to this configuration, the IO device is able to acquire the ID list from a communication medium.

Here, the information IO system may further include a list generation device that has a list storage unit and a generating unit operable to generate the ID list and write the generated ID list to the list storage unit.

According to this configuration, a list generation device in the information IO system is able to generate the ID list.

The above object may also be achieved by an IO device via which an information usage device performs information input/output, and that has the information usage device perform part of processing for judging whether the information usage device is one of valid and revoked.

According to this configuration, an IO device reduces the processing load involved in judging whether an information usage device is valid or revoked, by having the information usage device perform part of the processing.

Here, the IO device may output an ID list to the information usage device, the ID list including one or more IDs, arranged according to a predetermined rule, that each correspond to a different valid or revoked device, receive range information indicating a target range from the information usage device, the target range, which is specified using the ID list, including a target ID corresponding to the information usage device, and use the received range information in judging whether the information usage device is valid or revoked.

According to this configuration, the IO device is able to judge whether the information usage device is valid or revoked using range information received from the information usage device. As a result, the IO device is, unlike the prior art, no longer required to check the entire content of the ID list, thus lightening the processing load on the IO device in judging whether another device is valid or revoked.

Here, the input/output device may include: an acquiring unit operable to acquire the ID list from an external source; an output unit operable to output the acquired ID list to the information usage device; an ID receiving unit operable to receive from the information usage device, the target ID and, as the range information, one or more IDs, extracted from the ID list by the information usage device, that are included within the target range; and a judging unit operable to judge whether the information usage device is valid or revoked, depending on whether the received target ID matches any of the IDs received as the range information, and to suppress the information input/output if the information usage device is judged to be revoked.

According to this configuration, the IO device receives from the information usage device a target ID and one or more IDs extracted from the ID list, and assesses the validity of the information usage device by judging whether the target ID matches any of the one or more extracted IDs. As a result, the IO device is, unlike the prior art, no longer required to check the entire content of the ID list, thus lightening the processing load on the IO device in judging whether another device is valid or revoked.

Here, the target ID may identify a certificate certifying the authenticity of a public key of the information usage device, each ID in the ID list may identify a certificate of a different revoked device, and the judging unit may judge the information usage device to be revoked if the target ID matches any of the one or more extracted IDs, and valid if the target ID does not match any of the one or more extracted IDs.

According to this configuration, the IO device judges the information usage device to be valid if the target ID does not match any of the one or more extracted IDs received from the information usage device.

Here, the ID list may have arranged therein according to the predetermined rule, certification data that certifies, with respect to each of one or more ranges, the authenticity of the one or more IDs included within the range, the ID receiving unit may receive from the information usage device, certification data, extracted from the ID list by the information usage device, that certifies the authenticity of the one or more extracted IDs, and the judging unit may verify the authenticity of the received certification data, and judges, if the authenticity is verified, whether the information usage device is valid or revoked.

According to this configuration, the IO device additionally receives certification data relating to extracted IDs from the information usage device, verifies the authenticity of the certification data, and is able to judge whether the information usage device is valid or revoked if the authenticity is verified.

Here, the extracted certification data may be signature data generated by performing a digital signature on the one or more extracted IDs, and the judging unit may store a public key corresponding to a secret key used in generating the signature data, and use the public key in verifying the authenticity of the signature data.

According to this configuration, signature data generated by performing a digital signature on extracted IDs can be used as certification data.

Here, the extracted certification data may be an authenticator generated by using a 1st secret key on the one or more extracted IDs, and the judging unit may store a 2nd secret key that is identical to the 1st secret key, and use the 2nd secret key in verifying the authenticity of the authenticator.

According to this configuration, an authenticator generated by using a 1st secret key on extracted IDs can be used as certification data.

Here, the target ID may identify a certificate certifying the authenticity of a public key of the information usage device, each ID in the ID list may identify a certificate of a different valid device, the ID receiving unit may receive the target ID and a single extracted ID, and the judging unit may judge the information usage device to be valid if the target and extracted IDs match, and revoked if the target and extracted IDs do not match.

According to this configuration, the IO device judges the information usage device to be valid if the target ID matches an extracted ID received from the information usage device.

Here, the ID list may have arranged therein one or more pieces of certification data, each corresponded to and certifying the authenticity of a different one of the IDs, the ID receiving unit may receive from the information usage device, certification data, extracted from the ID list by the information usage device, that certifies the authenticity of the extracted ID, and the judging unit may verify the authenticity of the received certification data and judge, if the authenticity is verified, whether the information usage device is valid or revoked.

According to this configuration, the IO device additionally receives certification data relating to extracted IDs from the information usage device, verifies the authenticity of the certification data, and is able to judge whether the information usage device is valid or revoked if the authenticity is verified.

Here, the target ID may be included in a certificate certifying the authenticity of a public key of the information usage device, each ID in the ID list may be included in a certificate of a different valid or revoked device, and the ID receiving unit may receive from the information usage device, the target ID, and two extracted IDs defining the target range, which is a range showing the certificates of one of valid or revoked devices, and the judging unit may judge whether the information usage device is valid or revoked, depending on whether the target ID is included within the range defined by the two extracted IDs.

According to this configuration, the IO device is able to determine the validity of the information usage device by judging whether the target ID is included within a range defined by two extracted IDs received from the information usage device.

Here, the IO device may further include an information output unit operable to securely output usage information to the information usage device if the information usage device is judged to be valid.

According to this configuration, the IO device is able to output usage information to the information usage device if the information usage device is judged to be a valid device.

Here, the ID receiving unit may receive a public key of the information usage device, and the information output unit may use the received public key in encrypting the usage information to generate encrypted usage information and output the encrypted usage information to the information usage device.

According to this configuration, the IO device is able to encrypt usage information and output the encrypted usage information to the information usage device.

Here, the IO device may further include an ID storage unit operable to store a certificate ID that identifies a certificate certifying the authenticity of a public key of the IO device; and an ID output unit operable to output the certificate ID to the information usage device.

According to this configuration, the IO device is able to output a certificate of the IO device to the information usage device.

Here, the IO device may further include a processing unit operable to establish a secure communication channel between the IO device and the information usage device, if the information usage device is judged to be valid; and an information output unit operable to securely output usage information to the information usage device, if the secure communication channel is established.

According to this configuration, the IO device is able to output usage information to the information usage device and the information usage device is able to receive the usage information if a secure communication channel is established between the IO and information usage devices.

Here, the processing unit may judge that a secure communication channel has been established if a shared key is generated between the information usage and IO devices, and the information output unit may encrypt the usage information using the shared key to generate encrypted usage information, and output the encrypted usage information to the information usage device.

According to this configuration, the IO device is able to encrypt usage information using a shared key generated between the IO and information usage devices, and output the encrypted usage information to the information usage device.

The above object may also be achieved by an information usage device that performs information input/output via an IO device, and, when instructed by the IO device, performs part of processing for judging whether the information usage device is one of valid and revoked.

According to this configuration, the processing load on an IO device involved in judging whether an information usage device is valid or revoked is reduced by the information usage device performing part of the processing.

Here, the information usage device may receive an ID list from the IO device, the ID list including one or more IDs, arranged according to a predetermined rule, that each correspond to a different valid or revoked device, and, as part of the judgment processing, use the received ID list in specifying a target range that includes a target ID stored by the information usage device, and output range information indicating the specified target range to the IO device.

According to this configuration, the information usage device is able, as part of the judgment processing, to specify a target range using an ID list received from the IO device and to output range information that indicates the specified range to the IO device.

Here, the information usage device may include: a storage unit operable to store the target ID, which corresponds to the information usage device; a receiving unit operable to receive the ID list from the IO device; an extracting unit operable to use the received ID list in specifying the target range, and to extract all of the IDs included within the specified target range from the ID list; and a data output unit operable to output to the IO device the target ID and the one or more IDs extracted as the range information.

According to this configuration, the information usage device is able to specify a target range that includes the target ID, extract the one or more IDs included within the target range from the ID list, and output the target ID and the IDs extracted as range information to the IO device.

Here, the extracting unit may specify the target range from one or more ranges each defined by two IDs arranged consecutively in the ID list, and extract the two IDs defining the specified target range, and the data output unit may output to the IO device the target ID and the two IDs extracted as the range information.

According to this configuration, the information usage device is able to extract two IDs from the ID list and output the extracted IDs to the IO device as range information.

Here, the target ID may identify a certificate certifying the authenticity of a public key of the information usage device, each ID in the ID list may identify a certificate of a different revoked device, and the extracting unit may extract in the arranged order, the one or more IDs included within the specified target range.

According to this configuration, the target ID identifies a certificate of the information usage device, and each ID in the ID list identifies a certificate of a revoked device.

Here, the ID list may have arranged therein according to the predetermined rule, certification data that certifies, with respect to each of one or more ranges, the authenticity of the one or more IDs included within the range, the extracting unit may extract from the ID list, the certification data certifying the authenticity of the one or more extracted IDs, and the data output unit may output the extracted certification data to the IO device.

According to this configuration, the information usage device is able to extract certification data certifying the authenticity of extracted IDs, and to output the extracted certification data to the IO device.

Here, the extracted certification data may be signature data generated by performing a digital signature on the one or more extracted IDs.

According to this configuration, signature data generated by performing a digital signature on extracted IDs can be used as certification data.

Here, the extracted certification data may be an authenticator generated by using a common secret key that is identical to a secret key of the IO device on the one or more extracted IDs.

According to this configuration, an authenticator generated by using a common secret key on extracted IDs can be used as certification data.

Here, the target ID may identify a certificate certifying the authenticity of a public key of the information usage device, each ID in the ID list may identify a certificate of a different valid device, and the extracting unit may judge whether any of the IDs in the ID list match the target ID, and extract the matching ID if judged in the affirmative.

According to this configuration, the target ID identifies a certificate of the information usage device, and each ID in the ID list identifies a certificate of a valid device.

Here, the ID list may have arranged therein one or more pieces of certification data, each corresponded to and certifying the authenticity of a different one of the IDs, the extracting unit may extract the certification data corresponding to the extracted ID, and the data output unit may output the extracted certification data to the IO device.

According to this configuration, the information usage device is able to extract certification data certifying the authenticity of extracted IDs, and output the extracted certification data to the IO device.

Here, the target ID may be included in a certificate certifying the authenticity of a public key of the information usage device, each ID in the ID list may be included in a certificate of a different valid or revoked device, and the extracting unit may specify the target range, which is a range showing the certificates of one of valid or revoked devices, and extract the two IDs defining the specified target range.

According to this configuration, the information usage device is able to specify a target range, which is a range showing the certificates of either valid or revoked devices, and extract the two IDs defining the specified target range from the ID list.

Here, the information usage device may further include a usage unit operable to securely receive usage information from the IO device if judged by the IO device that the information usage device is valid, and to use the received usage information.

According to this configuration, the information usage device is able to receive usage information from the IO device if judged by the IO device to be a valid device, and to use the received usage information.

Here, the usage information may have been encrypted in the IO device using a public key of the information usage device, and the usage unit may store a secret key corresponding to the public key, and on receipt of the encrypted usage information from the IO device, decrypt the encrypted usage information using the secret key to generate usage information and use the generated usage information.

According to this configuration, the information usage device is able to receive encrypted usage information from the IO device, decrypt the encrypted usage information to generate usage information, and use the generated usage information.

Here, the information usage device may further include an ID reception unit operable to receive from the IO device a certificate ID that identifies a certificate certifying the authenticity of a public key of the IO device; a list receiving unit operable to receive a revocation list via the IO device, the revocation list including one or more revoked IDs that each identify a certificate of a different revoked device; and an ID judging unit operable to judge whether the IO device is valid or revoked, depending on whether the received certificate ID matches any of the revoked IDs included in the revocation list.

According to this configuration, the information usage device is able to judge whether the IO device is valid or revoked.

Here, the information usage device may further include a processing unit operable to establish a secure communication channel between the information usage device and the IO device, if the IO device is judged to be valid; and a usage unit operable to securely receive usage information from the IO device if the secure communication channel is established, and to use the received usage information.

According to this configuration, the information usage device is able to receive usage information from the IO device if a secure communication channel is established between the information usage and IO devices.

Here, the processing unit may judge that a secure communication channel has been established if a shared key is generated between the information usage and IO devices, the usage information may have been encrypted in the IO device using the shared key, and the usage unit, on receipt of the encrypted usage information from the IO device, may decrypt the encrypted usage information using the shared key and use the generated usage information.

According to this configuration, the information usage device is able to receive encrypted usage information from the IO device, decrypt the encrypted usage information to generate usage information, and use the generated usage information.

The above object may also be achieved by a list generation device for generating an ID list that includes one or more IDs corresponding to one or more valid or revoked devices, the list generation device including: a list storage unit; an acquiring unit operable to acquire one or more IDs; and a generating unit operable to arrange the acquired IDs according to a predetermined rule to generate an ID list that includes the arranged IDs, and to write the generated ID list to the list storage unit.

According to this configuration, a list generation device is able to generate an ID list that includes one or more IDs.

Here, each ID in the ID list may identify a certificate of a different revoked device, and the generating unit may include a key storage subunit operable to store a secret key; an arranging subunit operable to arrange the acquired IDs according to the predetermined rule; a data generating subunit operable to extract, in the arranged order of the IDs, one or more IDs constituting a range, and to use the secret key in generating certification data that certifies the authenticity of the one or more extracted IDs; a control subunit operable to control the data generating subunit to repeat the ID extraction and the data generation, until the data generation has been completed for all of the IDs; and a list generating subunit operable, after the completion of the data generation for all of the IDs, to generate an ID list that includes the arranged IDs and the generated certification data arranged according to the predetermined rule, and to write the generated ID list to the list storage unit.

According to this configuration, each ID in the ID list identifies a certificate of a revoked device, and the list generation device is able to generate an ID list that includes IDs and certification data arranged according to a predetermined rule.

Here, each ID in the ID list may identify a certificate of a different valid device, and the generating unit may include a key storage subunit operable to store a secret key; a data generating subunit operable to use the secret key in performing a digital signature on each of the acquired IDs to generate certification data certifying the authenticity of the ID; and a list generating unit operable to generate an ID list in which the arranged IDs are corresponded with respective pieces of the generated certification data, and to write the generated ID list to the list storage unit.

According to this configuration, each ID in the ID list identifies a certificate of a valid device, and the list generation device is able to generate an ID list that includes IDs and certification data arranged according to a predetermined rule.

The above object may also be achieved by an information IO system that includes an IO device and application software for performing information input/output via the IO device, the IO device having the application software perform part of processing for judging whether the application software is one of valid and revoked.

According to this configuration, an IO device in an information IO system is able to reduce the processing load on the IO device involved in judging whether application software is valid or revoked, by having the application software perform part of the processing.

### BRIEF DESCRIPTION OF THE DRAWINGS

FIG. 1 is a block diagram showing an overview of an authentication system 1;

FIG. 2 is a block diagram showing a structure of a CA terminal 10;

FIG. 3 shows a data structure of a playback device CRL 16 stored in a CRL storage unit 12;

FIG. 4 is a block diagram showing the respective structures of a recording medium 100, a playback device 200, and a reading device 300;

FIG. 5 is a block diagram showing the structures of different areas on recording medium 100;

FIG. 6 is a block diagram showing a structure of a verification unit 302;

FIG. 7 is a flowchart showing operations performed to generate a CRL;

FIG. 8 is a flowchart showing operations performed to write a CRL to recording medium 100;

FIG. 9 is a flowchart showing operations performed in playback device 200 and reading device 300 (cont. in FIG. 10);

FIG. 10 is a flowchart showing operations performed in devices 200 and 300 (cont. in FIG. 11);

FIG. 11 is a flowchart showing operations performed in devices 200 and 300 (cont. in FIG. 12);

FIG. 12 is a flowchart showing operations performed in devices 200 and 300 (cont. from FIG. 11);

FIG. 13 is a block diagram showing the respective structures of a recording medium 500, a playback device 600, and a reading device 700;

FIG. 14 is a block diagram showing the structures of different areas on recording medium 500;

FIG. 15 is a block diagram showing a structure of a verification unit 606;

FIG. 16 is a block diagram showing a structure of a verification unit 703;

FIG. 17 is a flowchart showing operations performed in playback device 600 and reading device 700 (cont. in FIG. 18);

FIG. 18 is a flowchart showing operations performed in devices 600 and 700 (cont. in FIG. 19);

FIG. 19 is a flowchart showing operations performed in devices 600 and 700 (cont. in FIG. 20);

FIG. 20 is a flowchart showing operations performed in devices 600 and 700 (cont. from FIG. 19);

FIG. 21 is a flowchart showing SAC processing operations performed between playback device 600 and reading device 700 (cont. in FIG. 22);

FIG. 22 is a flowchart showing SAC processing operations performed between devices 600 and 700 (cont. in FIG. 23);

FIG. 23 is a flowchart showing SAC processing operations performed between devices 600 and 700 (cont. from FIG. 22);

FIG. 24 is a block diagram showing the structures of different areas on a recording medium 500A;

FIG. 25 is a block diagram showing the structures of different areas on a recording medium 500B;

FIG. 26 shows a data structure of a playback device CRL 1000;

FIG. 27 shows a data structure of a playback device CRL 1001; and

FIG. 28 shows a data structure of a mixed list 1002.

### BEST MODE FOR CARRYING OUT THE INVENTION

Embodiments of an authentication system pertaining to the present invention are described below with reference to the drawings.

1. Embodiment 1

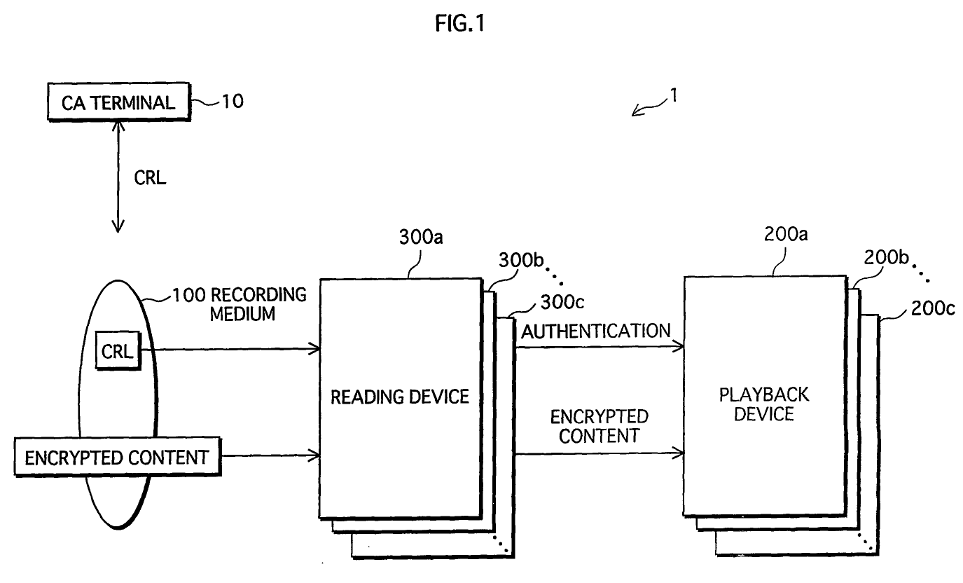

Shown in FIG. 1 is a block diagram of an authentication system 1 as an embodiment 1 pertaining to the present invention.

Authentication system 1 is constituted from a CA terminal 10, a recording medium 100, and a plurality of playback devices (200a, 200b, . . . , 200c) and reading devices (300a, 300b, 300c).

CA terminal 10, which is managed by a certification authority (CA), issues public-key certificates certifying the authenticity of the public keys of playback devices, and issues a certificate revocation list (CRL) showing a list of issued public-key certificates that have been revoked. Each public-key certificate (hereinafter simply “certificate”) includes a public key, an identifier (ID) identifying the certificate, and a certificate signature (signature of CA) for the public key and ID. Here, a certificate signature is signature data generated by performing a digital signature using a secret key (SK_CA) held only by the CA. Digital signatures that use an RSA (Rivest-Shamir-Adleman) cryptosystem employing hash functions are one example.

Recording medium 100 stores encrypted content and a CRL issued by CA terminal 10.

The playback devices and reading devices form pairs (i.e. 200a/300a, 200b/300b, . . . ), and recording medium 100 is used by these respective pairs.

For example, consider recording medium 100 being used by the pairing of playback device 200a and reading device 300a. In this case, device 300a reads the CRL and encrypted content from medium 100, and device 200a decrypts and plays the encrypted content read by device 300a.

Reading device 300a, which is connected to playback device 200a via a general communication channel, performs one-way authentication to authenticate device 200a and only outputs the encrypted content to device 200a if authentication is successful. Device 200a decrypts and plays encrypted content received from device 300a. Here, the general communication channel, whose specifications are well known, is an unsecured communication channel exposed to dangers such as wiretapping and falsification/replacement of data.

Note that since the device 200a/300a relationship applies equally to devices 200b/300b, 200c/300c, . . . , related description is omitted here.

1.1 Structure of CA Terminal 10

CA terminal 10 issues the certificate of the playback devices, updates the playback device CRL whenever an issued certificates is revoked, and stores the updated CRL.

CA terminal 10 also records the stored CRL to recording medium 100.

Note that since CA terminal 10 uses a convention method for issuing certificates, related description is omitted here.

The following description relates to generating and writing a CRL to recording medium 100.

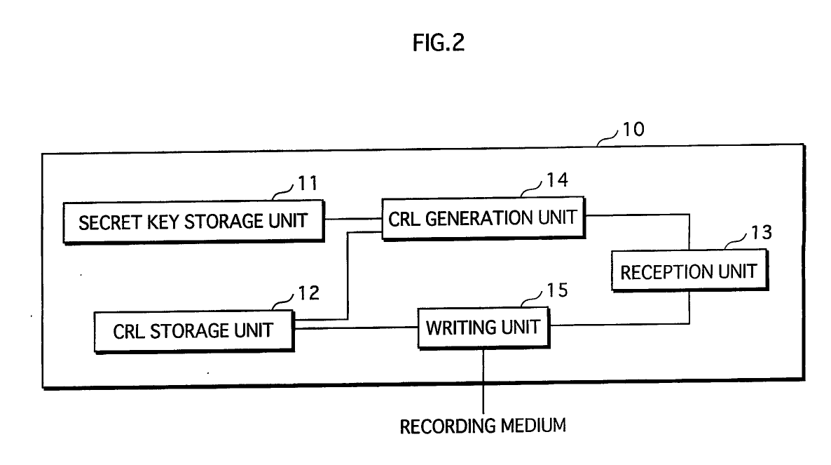

CA terminal 10 is, as shown in FIG. 2, constituted from a secret key (SK) storage unit 11, a CRL storage unit 12, a reception unit 13, a CRL generation unit 14, and a writing unit 15.

CA terminal 10 is, specifically, a computer system constituted from a microprocessor, ROM, RAM, a hard disk unit, and the like. The ROM or hard disk unit stores a computer program, and CA terminal 10 performs functions as a result of the microprocessor operating in accordance with the computer program.

(1) SK Storage Unit 11

SK storage unit 11 securely stores a secret key (SK_CA) held only by the CA, in a state in which external access is not possible.

(2) CRL Storage Unit 12

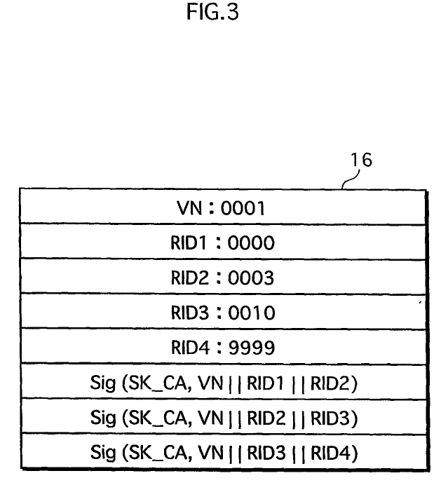

CRL storage unit 12 stores a CRL 16 relating to playback devices (see FIG. 3) that is generated in CA terminal 10.

Playback device CRL 16 (hereinafter “playback device CRL 16” or simply “CRL 16”) is constituted from three main areas storing, respectively, the version number (VN) of the CRL, a plurality of revoked certificate IDs (RID), and one or more signatures certifying the authenticity of the version number and RIDs. The signatures recorded in CRL 16 are hereinafter referred to as “CRL signatures”. A CRL signature is signature data generated by performing a digital signature using the secret key (SK_CA) held only by the CA. Digital signatures that use an RSA cryptosystem employing hash functions are one example.

CRL 16 in FIG. 3 gives an example in which certificates having the IDs “3” and “10” are revoked. As shown in FIG. 3, IDs “0000” and “9999” not allocated to actual certificates are also recorded in CRL 16. The version number is a value incremented by “1” whenever CRL 16 is updated. The CRL signatures are provided for values obtained by concatenating the version number and consecutively arranged RIDs. Here, the symbol “∥” is used to indicate the concatenation of data, and function Sig(X,Y) is used to sign data Y using key data X.

The RIDs are recorded in CRL 16 in ascending order, and the CRL signatures are recorded in CRL 16 so that the pairs of IDs signed along with the version number are arranged in ascending order. In FIG. 3, for example, the ID pairs for signing, when enumerated in ascending order, are “RID1 and RID2”, “RID2 and RID3”, and “RID3 and RID4”. These pairings are signed together with the version number in this order using the CA's secret key (SK_CA) to generate CRL signatures, which are then recorded in CRL 16.

The initial state of CRL 16 is, for example, constituted from a version number “0000”, two RIDs “0000” and “9999”, and a single CRL signature “Sig(SK_CA,0000∥0000∥9999)”.

(3) Reception Unit 13

Reception unit 13, on receipt of a CRL generation instruction and the IDs of all revoked certificates from an authorized user of CA terminal 10, outputs a CRL generation instruction and the received IDs to CRL generation unit 14.

Reception unit 13, when instructed by an authorized user of CA terminal 10 to write the CRL stored in CRL storage unit 12 to recording medium 100, instructs writing unit 15 to write the CRL to recording medium 100.

(4) CRL Generation Unit 14

CRL generation unit 14 has a temporary storage area for temporarily storing a CRL generated by unit 14. Note that the temporary storage area, like CRL 16, stores a version number, a plurality of RIDs, and one or more CRL signatures.

CRL generation unit 14, on receipt from reception unit 13 of a CRL generation instruction and the IDs of all revoked certificates, reads all of the RIDs recorded in CRL 16, uses the received IDs and read RIDs to arrange the IDs in ascending order, and stores the arranged IDs in the temporary storage area. The effect of this is to update the RIDs.

CRL generation unit 14 also acquires the version number from CRL 16, adds “1” to the acquired number to update the version number, and stores the updated version number in the temporary storage area.

CRL generation unit 14 uses the secret key (SK_CA), the version number, and the plurality of RIDs stored in the temporary storage area to generate CRL signatures for the version number and RID pairings, stores the generated CRL signatures in the temporary storage area, and generates a playback device CRL for recording to recording medium 100.

CRL generation unit 14, having generated and stored the CRL signatures in the temporary storage area, updates the content of CRL 16 stored in CRL storage unit 12 to the content stored in the temporary storage area.

Generation of CRL Signatures: Here, the number of revoked IDs stored in the temporary storage area (i.e. the number of RIDs) is given as “m” (m≧2). The RIDs stored in the temporary storage area, in ascending order of the ID values, are referred to as the 1^{st} RID, 2^{nd} RID, . . . m^{th} RID.

CRL generation unit 14 reads the secret key (SK_CA) from SK storage unit 11.

CRL generation unit 14 reads the version number and 1^{st}/2^{nd} RIDs from the temporary storage area, concatenates the read version number and RIDs, uses the read secret key (SK_CA) on the concatenated value to generate signature data, and stores the generated signature data in the temporary storage area as a CRL signature. Unit 14 then reads the 2^{nd}/3^{rd} RIDs, concatenates the version number read previously with the 2^{nd} and 3^{rd} RIDs, uses the secret key (SK_CA) on the concatenated value to generate signature data, and stores the generated signature data in the temporary storage area directly following the previously stored CRL signature.

CRL generation unit 14 repeats the above operation until the signature data for the version number and the m−1^{th}/m^{th} RIDs has been generated and stored in the temporary storage area directly following the previously stored CRL signature.

CRL generation unit 14 is thus able to generate a playback device CRL.

Specific Example: Illustrated here is a specific example of CRL signature generation. In the given example, version number “VN:0002” and five RIDs are stored in the temporary storage area. These five RIDs are given as “RID1:0000”, “RID2:0003”, “RID3:0010”, “RID4:0015” and “RID5:9999”.

CRL generation unit 14 firstly reads version number “VN:0002” and the two RIDs “RID1:0000” and “RID2:0003” from the temporary storage area, generates signature data Sig(SK_CA,VN∥RID1∥RID2) using the secret key (SK_CA), and stores the generated signature data in the temporary storage area as a CRL signature. Unit 14 then read the two RIDs “RID2:0003” and “RID3:0010”, generates signature data Sig(SK_CA,VN∥RID2∥RID3), and stores the generated signature data in the temporary storage area directly following Sig(SK_CA,VN∥RID1∥RID2).

As a result of repeating this operation, CRL generation unit 14 stores in the temporary storage area as CRL signatures in the stated order: Sig(SK_CA,VN∥RID1∥RID2), Sig(SK_CA,VN∥RID2∥RID3), Sig(SK_CA,VN∥RID3∥RID4), and Sig(SK_CA,VN∥RID4∥RID5).

CRL generation unit 14 then updates the content of CRL 16 stored in CRL storage unit 12 to the content stored in the temporary storage area.

(5) Writing Unit 15

Writing unit 15, when instructed by reception unit 13 to write a CRL, reads the CRL stored in CRL storage unit 12 and writes the read CRL to recording medium 100.

For example, if CRL 16 shown in FIG. 3 is stored in CRL storage unit 12, writing unit 15 writes this CRL to recording medium 100.

1.2 Structure of Recording Medium 100

The structure of recording medium 100 is described here.

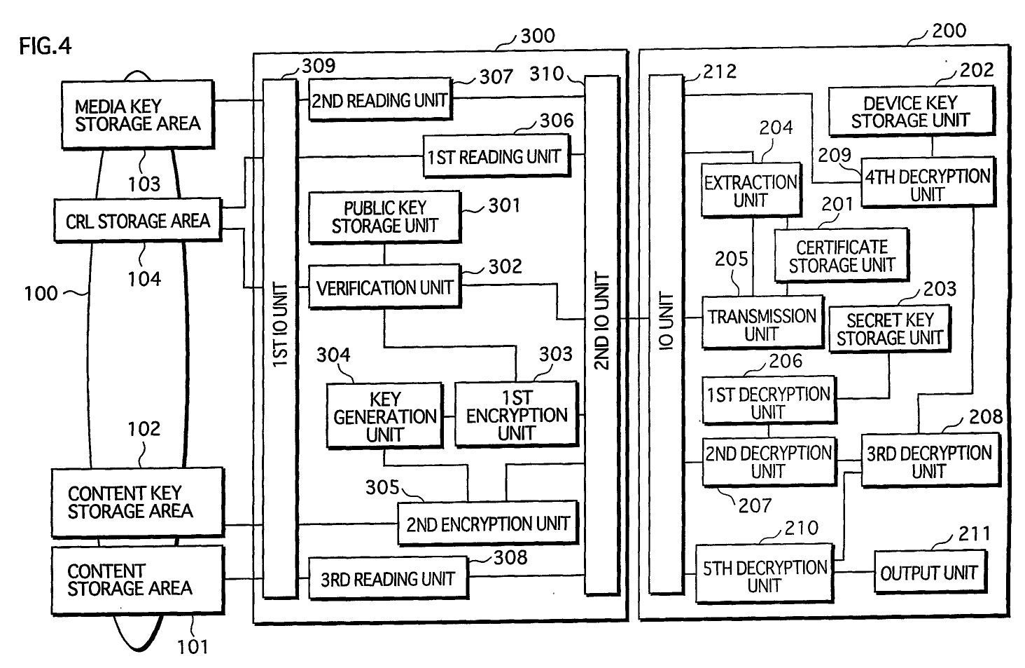

Recording medium 100 is, as shown in FIG. 4, constituted from a content storage area 101, a content key (CK) storage area 102, a media key (MK) storage area 103, and a CRL storage area 104.

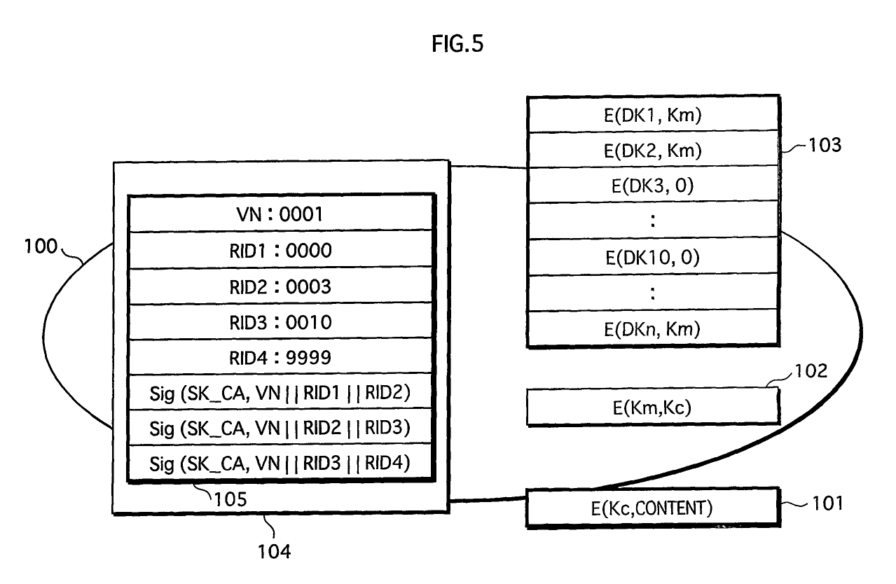

These recording areas are described below using FIG. 5.

(1) Content Storage Area 101

Content storage area 101 stores encrypted content generated by using a content key (Kc) to encrypt content with a common key (CK) encryption algorithm (e.g. Data Encryption Standard (DES) algorithm).

Note that a function E(X,Y) is used to encrypt data Y using data X.

(2) Content Key Storage Area 102

Content key storage area 102 stores an encrypted content key generated by using a media key (Km) to encrypt content key (Kc) with a CK encryption algorithm (e.g. DES algorithm).

(3) Media Key Storage Area 103

Media key storage area 103 stores one or more encrypted media keys generated by using a device key (DK) held for each playback device 200 to encrypt data provided for the playback device with a CK encryption algorithm (e.g. DES algorithm).

Here, each device key held for a playback device is corresponded to a DK identifier that uniquely identifies the device key, the one or more encrypted media keys in MK storage area 103 being stored in ascending order of the DK identifiers. That is, the device keys “DK1, DK2, DK3, . . . , DKn” shown in FIG. 5 are arranged in ascending order of the DK identifiers corresponding to the device keys. Note that the DK identifiers corresponding to the device keys “DK1, DK2, DK3, . . . , DKn” are hereinafter set in the order “1, 2, 3, . . . , n”.

Encrypted media keys are pieces of data for providing media keys to certain specified playback devices only. Media key (Km) is encrypted with a device key held by playback devices provided with a media key, and dummy data “0” (i.e. not media key) is encrypted with a device key held by playback devices not provided with a media key. FIG. 5 shows an example in which a media key is not provided (i.e. dummy data is provided) to playback devices holding, respectively, the device keys “DK3” and “DK10”.

Note that while dummy data “0” is used here, any other data unrelated to the media keys may be used. For example, usable data includes another fixed value “0xFFFF”, information showing the date/time of media key encryption, and the device key of a revoked device.

A detailed description of the method for providing media keys only to certain specified playback devices, being realizable using arbitrary well-known technology, is not referred to here. One exemplary method disclosed in Reference 2 above involves managing keys using a tree structure.

(4) CRL Storage Area 104

CRL storage area 104 stores a CRL 105 relating to playback devices (hereinafter “playback device CRL 105” or simply “CRL 105”).

CRL 105, like CRL 16 in CA terminal 10, has three main areas storing, respectively, the version number (VN) of the CRL, a plurality of revoked certificate IDs (RIDs), and one or more CRL signatures certifying the authenticity of the version number and RIDs.

Note that a description of the data structure of these elements, being similar to CRL 16, is omitted here.

FIG. 5 shows an example in which certificates having the IDs “3” and “10” are revoked.

1.3 Structure of the Playback Devices

Playback devices 200a, 200b, . . . , 200c, all of which have similar structures, are described here using a single playback device 200. Device 200 is paired with a reading device 300.

Playback device 200, as shown in FIG. 4, is constituted from a certificate storage unit 201, a device key (DK) storage unit 202, a secret key (SK) storage unit 203, an extraction unit 204, a transmission unit 205, a 1st decryption unit 206, a 2nd decryption unit 207, a 3rd decryption unit 208, a 4th decryption unit 209, a 5th decryption unit 210, an output unit 211, and an input/output (IO) unit 212.

Playback device 200 is, specifically, a computer system constituted from a microprocessor, ROM, RAM, a hard disk unit, and the like. The ROM or hard disk unit stores a computer program, and device 200 performs functions as a result of the microprocessor operating in accordance with the computer program.

(1) Certificate Storage Unit 201

Certificate storage unit 201 stores the certificate of playback device 200.

(2) DK Storage Unit 202

DK storage unit 202 stores a device key held by playback device 200 and a DK identifier identifying the device key.

(3) SK Storage Unit 203

SK storage unit 203 securely stores a secret key corresponding to the public key included in the certificate stored in certificate storage unit 201, in a state in which external access is not possible.

(4) Extraction Unit 204

Extraction unit 204, on receipt from reading device 300 via IO unit 212 of detection information showing that recording medium 100 is mounted in device 300, instructs device 300 via IO unit 212 to read a CRL, and receives CRL 105 from device 300 via IO unit 212.

Extraction unit 204, on receipt of CRL 105, reads the certificate from certificate storage unit 201, and, using the read certificate, searches for and extracts from CRL 105 the version number, an interval corresponding to the ID included in the read certificate, and the CRL signature for the version number and interval. Here, “interval” is used to mean a range in a CRL defined by two RIDs (head/tail of range), with no other RIDs existing between the two RIDs. Note that the interval corresponding to the ID in the certificate is the interval out of all those in the CRL that contains the ID of the certificate. This interval is hereinafter referred to as an “ID interval”.

Extraction unit 204 generates extraction information constituted from the extracted version number, ID interval and CRL signature, and outputs the generated information to transmission unit 205.

Extraction Method: Described below is exemplary search/extract method.

Extraction unit 204 acquires the version number included in CRL 105.

Extraction unit 204 acquires all of the intervals from the plurality of RIDs included in CRL 105, arranges the acquired intervals in ascending order, and temporarily stores the arranged intervals. For example, if CRL 105 contains the data shown in FIG. 5, the intervals enumerated in ascending order will be stored by extraction unit 204 in the order “RID1˜RID2”, “RID2˜RID3”, and “RID3˜RID4”. Naturally, the RIDs at the head and tail of each interval (i.e. RIDs defining the interval) are the same two RIDs signed along with the version number using the CA's secret key (SK_CA).

Extraction unit 204 searches for and extracts ID intervals from the acquired intervals. Unit 204 then retrieves interval numbers showing the positioning of the extracted ID intervals amongst those stored in ascending order. For example, extracted ID interval “RID3˜RID4”, being the third of the stored intervals, has the interval number “3”.

Extraction unit 204 uses the retrieved interval numbers in extracting CRL signatures.

Here, the extraction of CRL signatures is facilitated by the fact that the CRL signatures are recorded in CRL 105 so that pairs of IDs signed along with the version number are arranged in ascending order, thus making it possible, using the retrieved interval numbers, to locate the position of CRL signatures for extracting from amongst the stored CRL signatures. In other words, an ID interval and the CRL signature relating to the ID interval are uniquely corresponded to one another. For example, if the interval number is “3”, the CRL signature for extracting is, in the case of the data shown in FIG. 5, the third of the stored CRL signatures.

Specific Example: Consider an example in which the state of recording medium 100 is as shown in FIG. 5 and the ID of the certificate held by playback device 200 is “5”. In this case, extraction unit 204 extracts the version number “VN=0001”, the ID interval “RID2=0003˜RID3=0010”, and the CRL signature Sig(SK_CA,VN∥RID2∥RID3). Likewise, if the certificate ID is “3”, unit 204 extracts the version number “VN=0001”, the ID interval “RID1=0000˜RID2=0003” or “RID2=0003˜RID3=0005”, and the CRL signature Sig(SK_CA,VN∥RID1∥RID2) or Sig(SK_CA,VN∥RID2∥RID3)

(5) Transmission Unit 205

Transmission unit 205, on receipt of extraction information from extraction unit 204, reads the certificate from certificate storage unit 201, and outputs the certificate and extraction information to reading device 300 via IO unit 212.

(6) 1st Decryption Unit 206

1st decryption unit 206 has a public key (PK) encryption algorithm (e.g. RSA algorithm).

1st decryption unit 206 receives an encrypted session key from reading device 300 via IO unit 212. Here, an encrypted session key is generated in device 300 by using the public key included in a certificate to encrypt a session key (generated in device 300) with the PK encryption algorithm.

1st decryption unit 206 reads the secret key from SK storage unit 203, uses the read secret key to decrypt the encrypted session key with the PK encryption algorithm to generate a session key, and outputs the generated key to 2nd decryption unit 207.

(7) 2nd Decryption Unit 207

2nd decryption unit 207 has a common key (CK) encryption algorithm (e.g. DES algorithm).

2nd decryption unit 207, on receipt of a session key from 1st decryption unit 206, requests reading device 300 via, IO unit 212 for a content key.

2nd decryption unit 207 receive from reading device 300 via IO unit 212 a double-encrypted content key generated in device 300 by using the session key to encrypt the encrypted content key with the same CK encryption algorithm as that of unit 207.

2nd decryption unit 207 uses the session key received from 1st decryption unit 206 to decrypt the double-encrypted content key with the CK encryption algorithm to generate an encrypted content key, and outputs the generated key to 3rd decryption unit 208.

(8) 3rd Decryption Unit 208

3rd decryption unit 208 has the same CK encryption algorithm as that used to generate encrypted content keys.

3rd decryption unit 208, on receipt of an encrypted content key from 2nd decryption unit 207, instructs 4th decryption unit 209 to acquire a media key.

3rd decryption unit 208, on receipt of a media key from 4th decryption unit 209, uses the media key to decrypt the encrypted content key with the CK encryption algorithm to generate a content key, and outputs the generated key to 5th decryption unit 210.

(9) 4th Decryption Unit 209

4th decryption unit 209 has the same CK encryption algorithm as that used to generate encrypted media keys.

4th decryption unit 209, when instructed by 3rd decryption unit 208 to acquire a media key, instructs reading device 300 via IO unit 212 to read an encrypted media key, and receives, from reading device 300 via IO unit 212, all of the encrypted media keys recorded on recording medium 100.

4th decryption unit 209 reads the device key and DK identifier from DK storage unit 202, uses the read DK identifier to acquire the key from among the encrypted media keys that corresponds to the read device key. If the read DK identifier is “2”, for example, unit 209 acquires the encrypted media key “E(DK2,Km)” shown as the second of the encrypted media keys. Likewise, if the read DK identifier is “10”, unit 209 acquires the encrypted media key “E(DK10,Km)” shown as the tenth of the encrypted media keys.

4th decryption unit 209 used the read device key to decrypt the acquired key with the CK encryption algorithm to generate a media key, and outputs the generated key to 3rd decryption unit 208.

(10) 5th Decryption Unit 210

5th decryption unit 210 has the same CK encryption algorithm as that used to generate encrypted content.

5th decryption unit 210, on receipt of a content key from 3rd decryption unit 208, instructs reading unit 300 via IO unit 212 to read encrypted content, and receives encrypted content from reading unit 300 via IO unit 212.

5th decryption unit 210 uses the content key to decrypt the encrypted content with the CK encryption algorithm to generate content, and outputs the generated content to output unit 211.

(11) Output Unit 211

Output unit 211, which includes a display and a speaker, for example, outputs content received from 5th decryption unit 210 externally.

(12) IO Unit 212

IO unit 212 performs data input/output between playback device 200 and reading device 300.

1.4 Structure of Reading Device 300

Reading devices 300a, 300b, . . . , 300c, all of which have similar structures, are described here using a single reading device 300. Device 300 is paired with playback device 200.

Reading device 300 is, as shown in FIG. 4, constituted from a CA public key (PK) storage unit 301, a verification unit 302, a 1st encryption unit 303, a key generation unit 304, a 2nd encryption unit 305, a 1st reading unit 306, a 2nd reading unit 307, a 3rd reading unit 308, a 1st input/output (IO) unit 309, and a 2nd input/output (IO) unit 310.

Reading device 300 is, specifically, a computer system constituted from a microprocessor, ROM, RAM, a hard disk unit, and the like. The ROM or hard disk unit stores a computer program, and device 300 performs functions as a result of the microprocessor operating in accordance with the computer program.

(1) PK Storage Unit 301

PK storage unit 301 stores a public key (hereinafter “CA public key”) that corresponds to the secret key (SK_CA) held only by the CA.

(2) Verification Unit 302

Verification unit 302 verifies certificates and CRL signatures, checks the version of CRL 105, and assesses the validity of certificates.

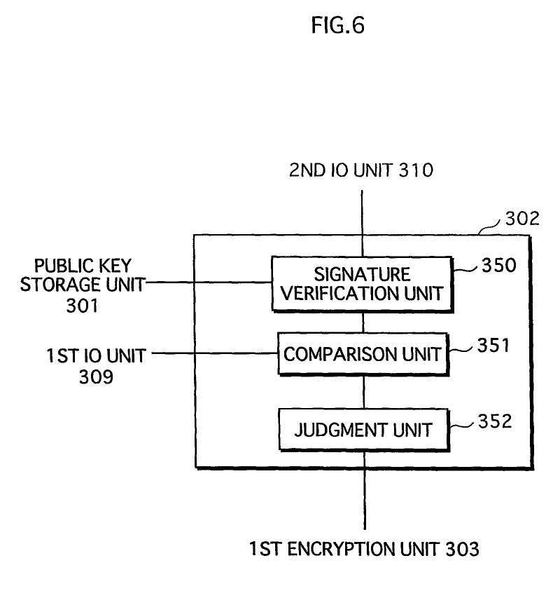

Verification unit 302, as shown in FIG. 6, includes a signature verification unit 350, a comparison unit 351, and a judgment unit 352.

Units 350, 351 and 352 are described below. Signature Verification Unit 350: On receipt of extraction information and a certificate from playback device 200 via 2nd IO unit 310, unit 350 reads the CA public key from PK storage unit 301.

Unit 350 uses the read public key in verifying the certificate and the CRL signature included in the extraction information, and outputs the certificate and extraction information to comparison unit 351 if the authenticity of the certificate and CRL signature is verified.

Comparison Unit 351: Unit 351 is able to access recording medium 100 via 1st IO unit 309.

Unit 351, on receipt of extraction information and a certificate from signature verification unit 350, reads CRL 105 from recording medium 100 via 1st IO unit 309, compares the version number included in CRL 105 with the version number included in the extraction information, and judges whether the version numbers match.

Unit 351 outputs the certificate and extraction information to judgment unit 352 if judged that the version numbers match.

Judgment Unit 352: On receipt of extraction information and a certificate from comparison unit 351, unit 352 uses the extraction information and certificate ID in judging whether the certificate is valid.

Unit 352 outputs the certificate to 1st encryption unit 303 if judged to be valid.

Described below is a method for judging the authenticity of certificates. If the ID of a received certificate belongs to an ID interval included in the extraction information but matches neither of the two RIDs defining the interval, unit 352 judges the certificate to be valid. On the other hand, if this is not the case (i.e. the certificate ID does not belong to the ID interval or matches one of RIDs defining the interval), unit 352 judges the certificate to be revoked.

If judged that a received certificate is valid, unit 352 is thus able to determine that playback device 200 is authorized (i.e. a valid device), and if judged that a received certificate is revoked, unit 352 is thus able to determine that device 200 is not authorized (i.e. a revoked device).

A further exemplary judgment method is given here. Judgment unit 352 judges a received certificate to be valid if the certificate ID is included in a valid interval, and to be revoked if the ID is not included in a valid interval. Here, “valid interval” is used to mean the range within an ID interval that excludes the two IDs defining the interval (i.e. head/tail IDs). If a valid interval does not exist (i.e. if the ID interval is defined by two consecutively numbered RIDs), unit 352 judges the received certificate to be revoked.

Naturally, judging that a certificate ID is included within a valid interval is the same as judging that a certificate ID belonging to an ID interval matches neither of the two RIDs defining the interval.

Specific Example: described here is a specific example of the judgment method using valid intervals.

Consider an example in which the certificate ID is “5” and the ID interval include in the extraction information is “RID2=0003˜RID3=0010”. Here, since the value “5” belongs to the valid interval, which is “4, 5, 6, 7, 8, 9”, unit 352 judges the certificate to be valid. Consider another example in which the certificate ID is “3” and the ID interval include in the extraction information is “RID2=0003˜RID3=0010”. Here, since the value “3” is not included within the valid interval, which again is “4, 5, 6, 7, 8, 9”, unit 352 judges that the certificate is not valid (i.e. revoked). Finally, consider an example in which the certificate ID is “15” and the ID interval include in the extraction information is “0015˜0016”. Here, since a valid interval does not exist, unit 352 judges the certificate to be revoked.

(3) 1st Encryption Unit 303

1st encryption unit 303 has the same PK encryption algorithm as 1st decryption unit 206 in playback device 200.

1st encryption unit 303, on receipt of a certificate from judgment unit 352, instructs key generation unit 304 to generate a session key.

1st encryption unit 303, on receipt of a session key from key generation unit 304, acquires the public key included in the certificate.

1st encryption unit 303 using the public key to encrypt the session key with the PK encryption algorithm to generate an encrypted session key, and outputs the generated key to 1st decryption unit 206 via 2nd IO unit 310.

(4) Key Generation Unit 304

Key generation unit 304 has a storage area for temporarily storing a session key required for transmitting information securely over the general communication channel that connects reading device 300 and playback device 200 (i.e. encrypted transmission).

Key generation unit 304 generates a session key when instructed to do so by 1st encryption unit 303, and outputs the generated key to unit 303 in addition to temporarily storing the key in the storage area.

(5) 2nd Encryption Unit 305

2nd encryption unit 305 has the same CK encryption algorithm as 2nd decryption unit 207 in playback device 200, and is able to access recording medium 100 via 1st IO unit 309.

2nd encryption unit 305, when requested for a content key by 2nd decryption unit 207 via 2nd IO unit 310, reads an encrypted content key from recording medium 100 via 1st IO unit 309, and reads the session key from key generation unit 304.

2nd encryption unit 305 uses the session key to encrypt the encrypted content key with the CK encryption algorithm to generate a double-encrypted content key, and outputs the double-encrypted content key to 2nd decryption unit 207 via 2nd IO unit 310.

(6) 1st Reading Unit 306

1st reading unit 306 is able to access recording medium 100 via 1st IO unit 309.

1st reading unit 306, on detecting via 1st IO unit 309 that recording medium 100 is mounted in reading device 300, generates detection information, and outputs the generated information to extraction unit 204 via 2nd IO unit 310.

1st reading unit 306, when instructed by extraction unit 204 via 2nd 10 unit 310 to read a CRL, reads CRL 105 from recording medium 100 via 1st IO unit 309, and outputs the read CRL to extraction unit 204 via 2nd IO unit 310.

(7) 2nd Reading Unit 307

2nd reading unit 307 is able to access recording medium 100 via 1st IO unit 309.

2nd reading unit 307, when instructed by 4th decryption unit 209 via 2nd IO unit 310 to read an encrypted media key, reads all of the encrypted media keys from recording medium 100 via 1st IO unit 309, and outputs the read keys to unit 209 via 2nd IO unit 310.

(8) 3rd Reading Unit 308

3rd reading unit 308 is able to access recording medium 100 via 1st IO unit 309.

3rd reading unit 308, when instructed by 5th decryption unit 210 via 2nd IO unit 310 to read encrypted content, reads encrypted content from recording medium 100 via 1st IO unit 309, and outputs the encrypted content to unit 210 via 2nd IO unit 310.

(9) 1st IO Unit 309

1st IO unit 309 outputs data recorded on recording medium 100 to verification unit 302, 2nd encryption unit 305, 1st reading unit 306, 2nd reading unit 307, and 3rd reading unit 308.

(10) 2nd IO Unit 310

2nd IO unit 310 performs data input/output between reading device 300 and playback device 200.

1.5 Operations of CA Terminal 10

The following description relates to processing performed by CA terminal 10 to generate and write a CRL.

(1) CRL Generation

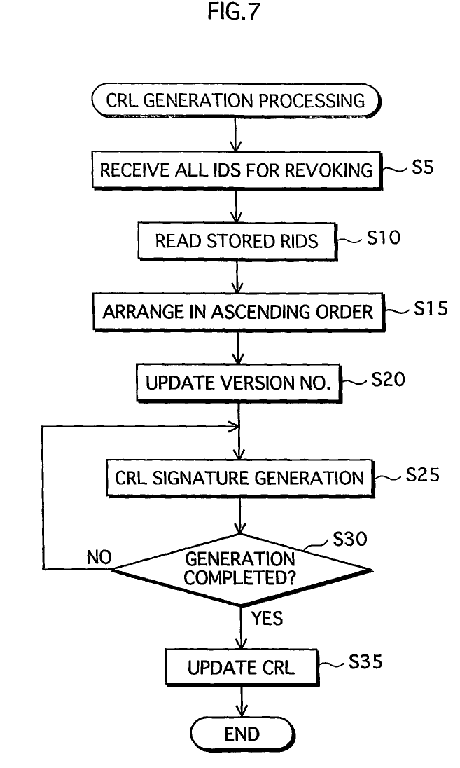

CRL generation is described using the flowchart shown in FIG. 7.

Reception unit 13 in CA terminal 10, on receipt of a CRL generation instruction and the IDs of all revoked certificates from an authorized user of CA terminal 10, outputs a CRL generation instruction and the received IDs to CRL generation unit 14 (step S5).

CRL generation unit 14, on receipt from reception unit 13 of a CRL generation instruction and the IDs of all revoked certificates, reads all of the RIDs recorded in CRL 16 (step S10), uses the received IDs and read RIDs in arranging the IDs in ascending order, and stores the arranged IDs in the temporary storage area (step S15).

CRL generation unit 14 acquires the version number from CRL 16, adds “1” to the acquired number to update the version number, and stores the updated version number in the temporary storage area (step S20).

CRL generation unit 14 reads the secret key from SK storage unit 11, uses the read key, the version number and the RIDs stored in the temporary storage area (number of RIDs=“m”; m≧2) to generate a CRL signature for the version number and 1^{st}/2^{nd} RIDs, and stores the generated CRL signature in the temporary storage area (step S25).

CRL generation unit 14 judges whether a CRL signature for the version number and m−1^{th}/m^{th} RIDs has been generated (step S30).

If judged in the negative (step S30=NO), CRL generation unit 14 reads the 2^{nd} and 3^{rd} RIDs from the temporary storage area, and performs step S25 to generate and store a CRL signature for the version number and 2^{nd}/3^{rd} RIDs. Unit 14 repeats step S25 until the CRL signature for the version number and m−1^{th}/m^{th} RIDs has been generated and stored in the temporary storage area.

If judged in the affirmative at step S30 (step S30=YES), CRL generation unit 14 at step S35 updates the content of CRL 16 stored in CRL storage unit 12 to the content stored in the temporary storage area (i.e. CRL after updating).

(2) Write Processing

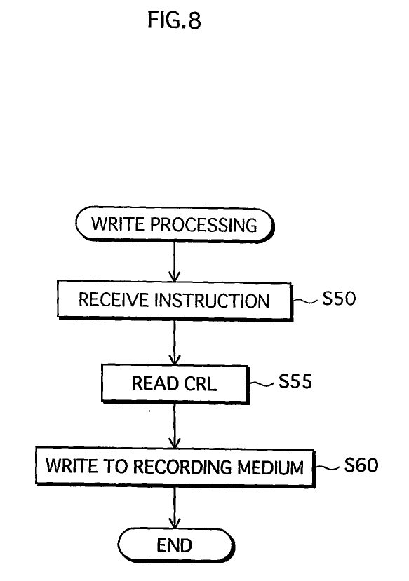

Processing to write a CRL to recording medium 100 is described here using the flowchart shown in FIG. 8.

Reception unit 13, when instructed by an authorized user of CA terminal 10 to write a CRL stored in CRL storage unit 12 to recording medium 100, instructs writing unit 15 to write a CRL to medium 100 (step S50).

Writing unit 15, on receipt of the instruction from reception unit 13, reads CRL 16 from CRL storage unit 12 (step S55), and writes the read CRL to recording medium 100.

1.6 Operations of Playback Device 200 and Reading Device 300

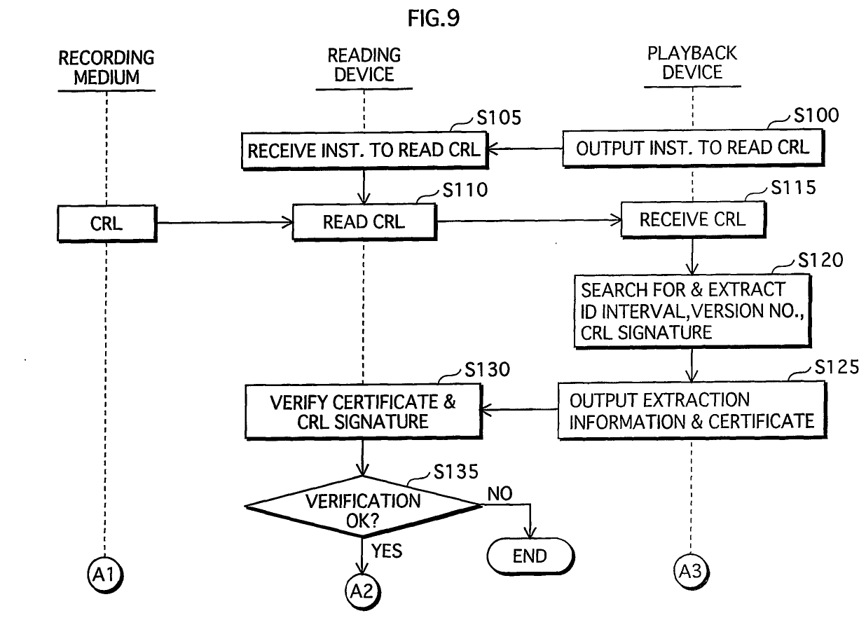

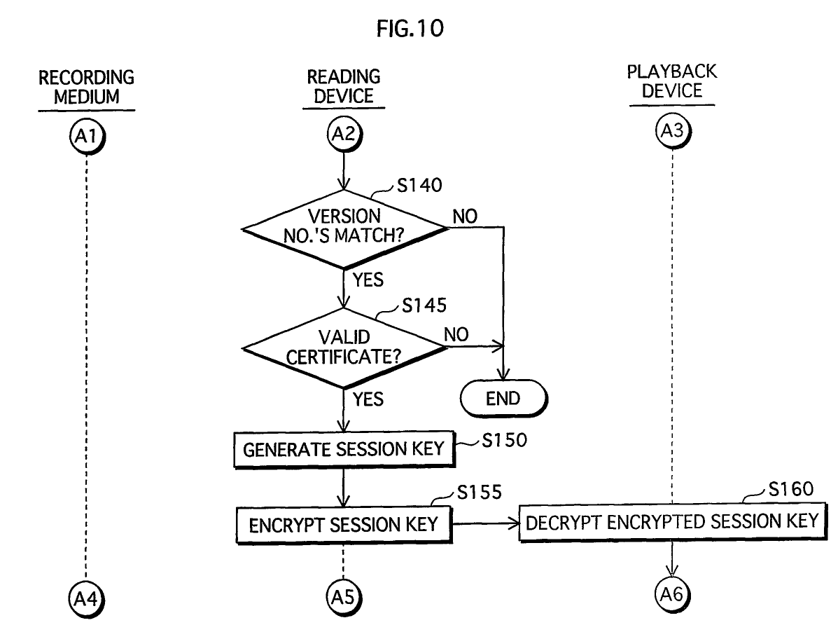

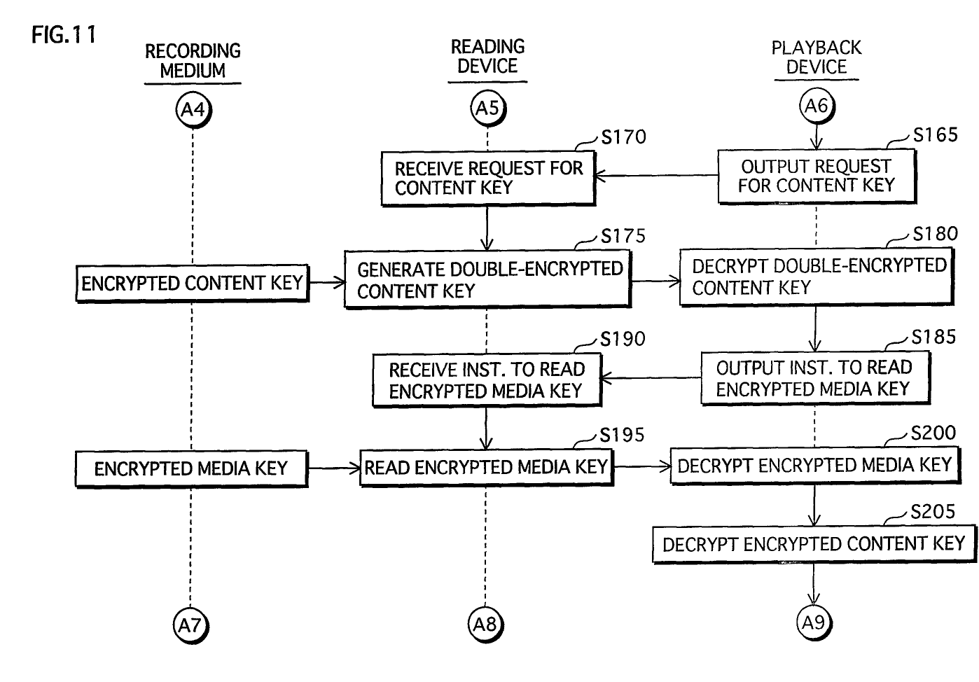

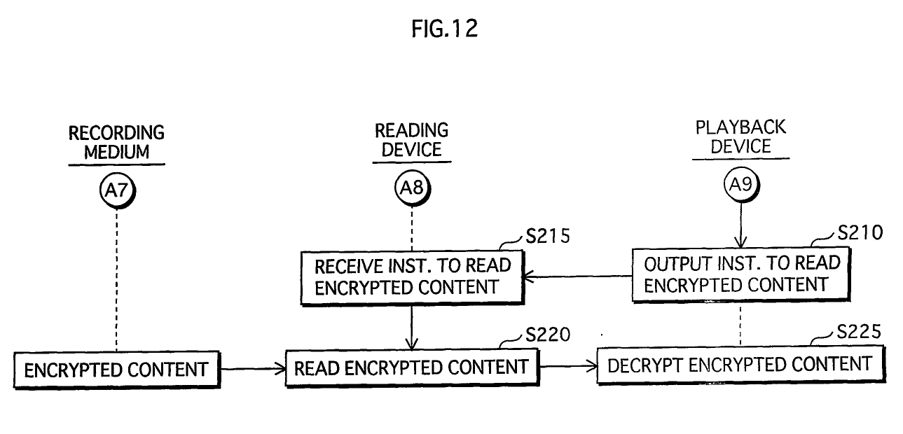

The operations relating to authentication and content playback in playback device 200 and reading device 300 are described here using the flowcharts shown in FIGS. 9, 10, 11 and 12.

Extraction unit 204 in playback device 200, on receipt of detection information from 1st reading unit 306 in reading device 300, instructs unit 306 via IO unit 212 to read a CRL (step S100).

1st reading unit 306, on receipt of the instruction from extraction unit 204 via 2nd IO unit 310 (step S105), reads CRL 105 from recording medium 100 via 1st IO unit 309, and outputs the read CRL to unit 204 via 2nd IO unit 310 (step S110).

Extraction unit 204, on receipt of CRL 105 via IO unit 212 (step S115), reads the certificate from certificate storage unit 201, and, using the read certificate, searches for and extracts from CRL 105 the version number, an interval corresponding to the ID included in the read certificate, and the CRL signature for the version number and interval (step S120).

Extraction unit 204 generates extraction information constituted from the extracted version number, ID interval and CRL signature, and outputs the generated information to transmission unit 205, which then reads the certificate from certificate storage unit 201, and outputs the certificate and extraction information to verification unit 302 via IO unit 212 (step S125).

Signature verification unit 350 in verification unit 302, on receipt of the certificate and extraction information via 2nd IO unit 310, reads the CA public key from PK storage unit 301, and uses the read key in verifying the certificate and the CRL signature included in the extraction information (step S130). Unit 350 determines whether the certificate and CRL signature are authentic depending on the verification result (step S135).

If the certificate and CRL signature are judged to be authentic (step S135=YES), signature verification unit 350 outputs the certificate and extraction information to comparison unit 351, which then reads CRL 105 from recording medium 100 via 1st IO unit 309, and compares the version number included in CRL 105 with the version number included in the extraction information, and judges whether the version numbers match (step S140).

If judged in the affirmative (step S140=YES), comparison unit 351 outputs the certificate and extraction information to judgment unit 352, which uses the received extraction information in judging whether the certificate is valid (step S145).

If judged to be valid (step S145=YES), judgment unit 352 outputs the certificate to 1st encryption unit 303, which then instructs key generation unit 304 to generate a key. In response, unit 304 generates a session key, and outputs the generated key to unit 303 in addition to storing the key internally (step S150).

The processing is ended if judged that the certificate is not authentic (step S135=NO), the version numbers do not match (step S140=NO), or the certificate is revoked (step S145=NO).

1st encryption unit 303, on receipt of the session key from key generation unit 304, acquires the public key included in the certificate received from judgment unit 352, and uses the public key to encrypt the session key with the PK encryption algorithm to generate an encrypted session key, and outputs the generated key to 1st decryption unit 206 via 2nd IO unit 310 (step S155).

1st decryption unit 206, on receipt of the encrypted session key via IO unit 212, reads the secret key from SK storage unit 203, and uses the read key to decrypt the encrypted key with the PK encryption algorithm to generate a session key, and outputs the generated key to 2nd decryption unit 207 (step S160), which then requests 2nd encryption unit 305 via IO unit 212 for a content key (step S165).

2nd encryption unit 305 on receipt of the request from 2nd decryption unit 207 via 2nd IO unit 310 (step S170), reads an encrypted content key from recording medium 100 via 1st IO unit 309, reads the session key from key generation unit 304, uses the session key to encrypt the encrypted content key with the CK encryption algorithm to generate a double-encrypted content key, and outputs the double-encrypted content key to unit 207 via 2nd IO unit 310 (step S175).

2nd decryption unit 207, on receipt of the double-encrypted content key via IO unit 212, uses the session key received from 1st decryption unit 206 to decrypt the double-encrypted content key with the CK encryption algorithm to generate an encrypted content key, and outputs the generated key to 3rd decryption unit 208 (step S180).

3rd decryption unit 208, on receipt of the encrypted content key, instructs 4th decryption unit 209 to acquire a media key. In response, unit 209 instructs 2nd reading unit 307 via IO unit 212 to read an encrypted media key (step S185).

2nd reading unit 307, on receipt of the instruction from 4th decryption unit 209 via 2nd IO unit 310 (step S190), reads all of the encrypted media keys from recording medium 100 via 1st IO unit 309, and outputs the read keys to unit 209 via 2nd IO unit 310 (step S195).

4th decryption unit 209, on receipt of the encrypted media keys via IO unit 212, reads the device key and DK identifier from DK storage unit 202, and uses the DK identifier in acquiring the key from among the encrypted media keys that corresponds to the device key, uses the device key to decrypt the acquired key with the CK encryption algorithm to generate a media key, and outputs the generated key to 3rd decryption unit 208 (step S200).

3rd decryption unit 208, on receipt of the media key, uses the received key to decrypt the encrypted content key with the CK encryption algorithm to generated a content key, and outputs the generated key to 5th decryption unit 210 (step S205), which then instructs 3rd reading unit 308 via IO unit 212 to read encrypted content (step S210).

3rd reading unit 308, on receipt of the instruction from 5th decryption unit 210 via 2nd IO unit 310 (step S215), reads encrypted content from recording medium 100 via 1st IO unit 309, and outputs the encrypted content to unit 210 via 2nd IO unit 310 (step S220).

5th decryption unit 210, on receipt of the encrypted content via IO unit 212, uses the content key to decrypt the encrypted content with the CK encryption algorithm to generate content, and outputs the generated content to output unit 211, which outputs the received content externally (step S225).

2. Embodiment 2

An authentication system 2, as an embodiment 2 pertaining to the present invention, differs from authentication system 1 of embodiment 1 in terms of the authentication method. Described below are a recording medium 500, playback devices 600a, 600b, . . . , 600c, and reading devices 700a, 700b, . . . , 700c according to embodiment 2.

A CA terminal 50 in embodiment 2, like CA terminal 10 in embodiment 1, issues public-key certificates for the playback devices and updates a playback device CRL. CA terminal 50 also issues public-key certificates for the reading devices and updates a reading device CRL.

Note that since the issuing of public-key certificates for the playback devices and the updating of a playback device CRL by CA terminal 50 are the same as in embodiment 1, and the issuing of public-key certificates for the reading devices and the updating of a reading device CRL by CA terminal 50 are the same as the prior art, related description is omitted here.

The pairing off of playback devices and reading devices is also the same in embodiment 1. That is, playback device 600a with reading device 700a, playback device 600b with reading device 700b, and so on.

2.1 Structure of Recording Medium 500

The structure of recording medium 500 is described here.

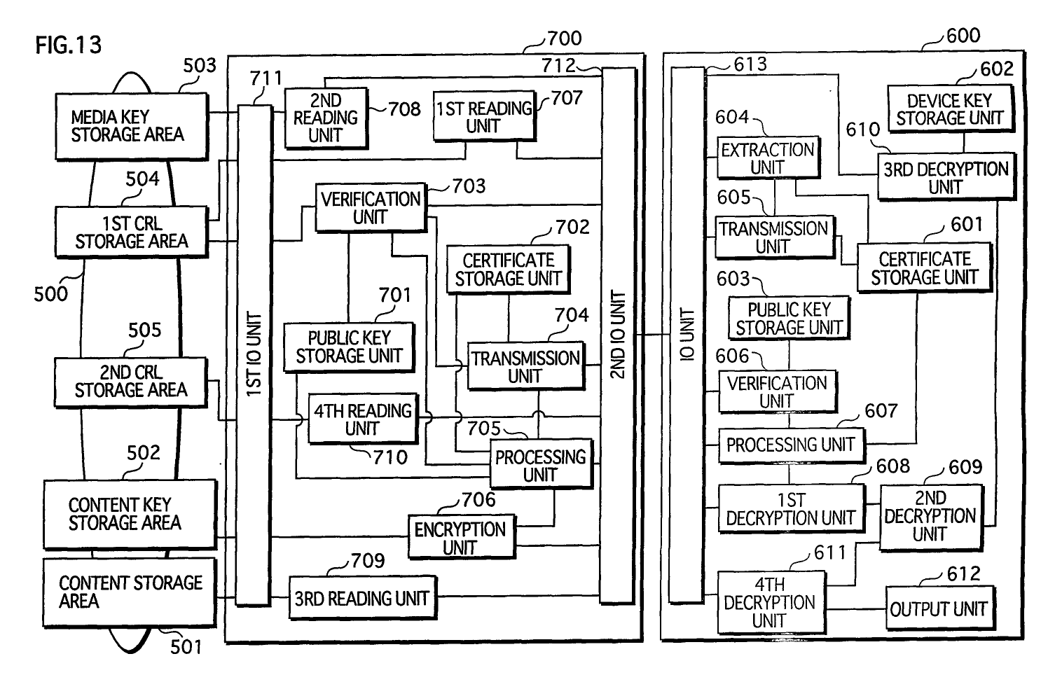

Recording medium 500 is, as shown in FIG. 13, constituted from a content storage area 501, a content key (CK) storage area 502, a media key (MK) storage area 503, a 1st CRL storage area 504, and a 2nd CRL storage area 505.

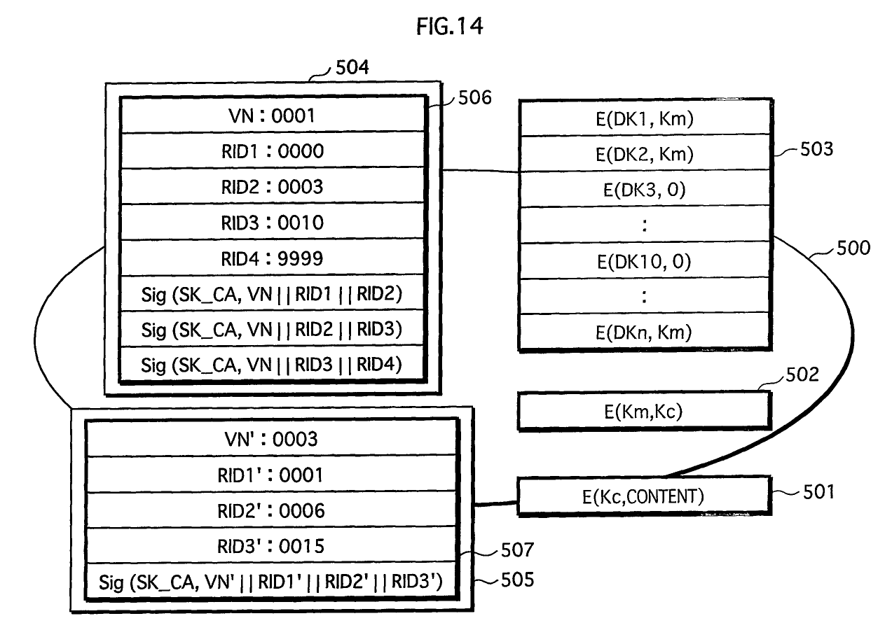

These recording areas are described below using FIG. 14.

(1) Content Storage Area 501

Content storage area 501 stores encrypted content generated by using a content key (Kc) to encrypt content with a CK encryption algorithm (e.g. DES algorithm).

(2) Content Key Storage Area 502

Content key storage area 502 stores an encrypted content key generated by using a media key (Km) to encrypt content key (Kc) with a CK encryption algorithm (e.g. DES algorithm).

(3) Media Key Storage Area 503

Media key storage area 503 stores one or more encrypted media keys generated by using a device key (DK) held for each playback device 600 to encrypt data provided for the playback device with a CK encryption algorithm (e.g. DES algorithm).

Here, each device key held for a playback device is corresponded to a DK identifier that uniquely identifies the device key, the one or more encrypted media keys in MK storage area 503 being stored in ascending order of the DK identifiers. Note that the DK identifiers corresponding respectively to the device keys “DK1, DK2, DK3, . . . , DKn” are hereinafter set in the order “1, 2, 3, . . . , n”.

(4) 1st CRL Storage Area 504

1st CRL storage area 504 stores a CRL 506 relating to playback devices (hereinafter “playback device CRL 506” or simply “CRL 506”).

CRL 506 has three main areas storing, respectively, the version number (VN) of the CRL, a plurality of revoked certificate IDs (RIDs), and one or more CRL signatures, which are signatures of the CA that certify the authenticity of the version number and RIDs.

FIG. 14 shows an example in which certificates having the IDs “3” and “10” are revoked. IDs “0000” and “9999” not allocated to actual certificates are also recorded in CRL 506. Also, the version number is a value incremented by “1” whenever CRL 506 is updated. CRL signatures are provided for values obtained by concatenating the version number and consecutively arranged RIDs.

Here, each CRL signature recorded in CRL 506 is signature data generated by performing a digital signature using the secret key (SK_CA) held only by the CA. Digital signatures that use an RSA cryptosystem employing hash functions are one example.

(5) 2nd CRL Storage Area 505

2nd CRL storage area 505 stores a CRL 507 relating to reading devices (hereinafter “reading device CRL 507” or simply “CRL 507”).

CRL 507 has there main areas storing, respectively, the version number (VN′) of the CRL, a plurality of revoked certificate IDs (RID′), and one or more CRL signatures, which are signatures of the CA that certify the authenticity of the version number and RIDs.

FIG. 14 shows an example in which certificates having the IDs “1”, “6” and “15” are revoked.

Here, each CRL signature recorded in CRL 507 is signature data generated by performing a digital signature using the secret key (SK_CA) held only by the CA. Digital signatures that use an RSA cryptosystem employing hash functions are one example.

2.2 Structure of the Playback Devices

Playback devices 600a, 600b, . . . , 600c, all of which have similar structures, are described here using a single playback device 600. Device 600 is paired with a reading device 700.

Playback device 600, as shown in FIG. 13, is constituted from a certificate storage unit 601, a device key (DK) storage unit 602, a CA public key (PK) storage unit 603, an extraction unit 604, a transmission unit 605, a verification unit 606, a processing unit 607, a 1st decryption unit 608, a 2nd decryption unit 609, a 3rd decryption unit 610, a 4th decryption unit 611, an output unit 612, and an input/output (IO) unit 613.

Playback device 600 is, specifically, a computer system constituted from a microprocessor, ROM, RAM, a hard disk unit, and the like. The ROM or hard disk unit stores a computer program, and device 600 performs functions as a result of the microprocessor operating in accordance with the computer program.

(1) Certificate Storage Unit 601

Certificate storage unit 601 stores the certificate of playback device 600.

(2) DK Storage Unit 602

DK storage unit 602 stores a device key held by playback device 600 and a DK identifier identifying the device key.

(3) PK Storage Unit 603

PK storage unit 603 stores a public key corresponding to the secret key (SK_CA) held only by the CA.

(4) Extraction Unit 604

Extraction unit 604, on receipt from reading device 700 via IO unit 613 of detection information showing that recording medium 500 is mounted in device 700, instructs device 700 via IO unit 613 to read CRL 506 (hereinafter “1st CRL read instruction”), and receives CRL 506 via IO unit 613.

Extraction unit 604, on receipt of CRL 506, reads the certificate from certificate storage unit 601, and, using the read certificate, searches for and extracts from CRL 506 the version number, an interval corresponding to the ID included in the read certificate, and the CRL signature for the version number and interval.

Extraction unit 604 generates extraction information constituted from the extracted version number, ID interval and CRL signature, and outputs the generated information to transmission unit 605.

Note that description of the extraction method, being similar to embodiment 1, is omitted here.

Specific Example: Consider an example in which the state of recording medium 500 is as shown in FIG. 14 and the ID of the certificate held by playback device 600 is “5”. In this case, extraction unit 604 extracts the version number “VN=0001”, the ID interval “RID2=0003˜RID3=0010”, and the CRL signature Sig(SK_CA,VN∥RID2∥RID3). Likewise, if the certificate ID is “3”, unit 604 extracts the version number “VN=0001”, the ID interval “RID1=0000˜RID2=0003” or “RID2=0003˜RID3=0005”, and the CRL signature Sig(SK_CA,VN∥RID1∥RID2) or Sig(SK_CA,VN∥RID2∥RID3)

(5) Transmission Unit 605

Transmission unit 605, on receipt of extraction information from extraction unit 604, reads the certificate from certificate storage unit 601, and outputs the certificate and extraction information to reading device 700 via IO unit 613.

(6) Verification Unit 606

Verification unit 606 verifies the certificates of reading devices and CRL signatures included in CRL 507, and assesses the validity of the certificates.

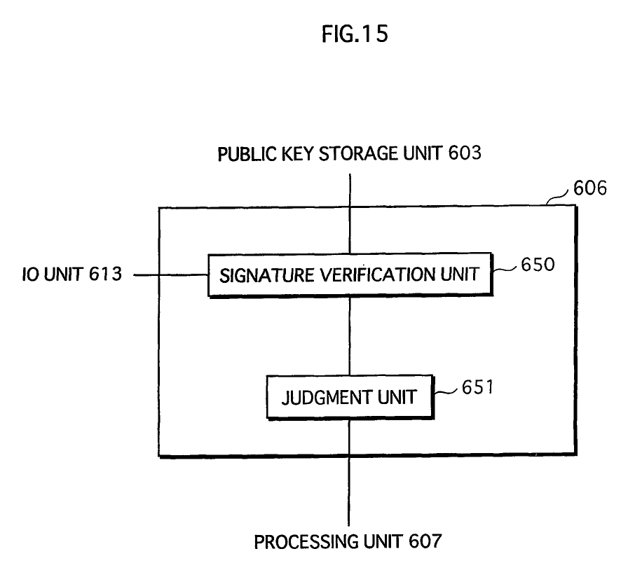

Verification unit 606, as shown in FIG. 15, includes a signature verification unit 650 and a judgment unit 651.

Units 650 and 651 are described below.

Signature Verification Unit 650: On receipt of a certificate from reading device 700 via IO unit 613, unit 650 instructs device 700 via IO unit 613 to read CRL 507 (i.e. 2nd CRL read instruction). On receipt of CRL 507 via IO unit 613, unit 650 reads the CA public key from PK storage unit 603.

Unit 650 uses the read public key in verifying the certificate and the CRL signature included in CRL 507, and outputs the certificate and CRL 507 to judgment unit 651 if the authenticity of the certificate and CRL signature is verified.

Judgment Unit 651: Unit 651 uses the certificate and CRL 507 received from signature verification unit 650 in judging whether the certificate is valid.

Unit 651 outputs CRL 507 and an instruction to start mutual authentication to processing unit 607 if the certificate is judged to be valid.

Here, the judgment method involves judging whether a RID matching the ID of the certificate exists in CRL 507. The certificate is judged to be revoked if a matching RID exists, and to be valid if a matching RID does not exist.

If judged that a received certificate is valid, unit 651 is thus able to determine that reading device 700 is authorized (i.e. a valid device), and if judged that a received certificate is revoked, unit 651 is thus able to determine that reading device 700 is not authorized (i.e. a revoked device).

Consider an example in which CRL 507 is outputted from a reading device holding a certificate whose ID is “5”. Since a “5” value does not exist in the received CRL, unit 651 judges the certificate to be valid. However, if CRL 507 is outputted from a reading device holding a certificate whose ID is “6”, unit 651 judges the certificate to be revoked, since a “6” value does exist in the received CRL.

(7) Processing Unit 607

Processing unit 607 performs mutual authentication between reading device 700 and playback device 600 via IO unit 613, in order to establish a secure authenticated channel (SAC) for safely transmitting information over the general communication channel connecting devices 600 and 700.

Processing unit 607 prestores the secret key held only by playback device 600, a system parameter “Y” unique to authentication system 2, a signature generation function “Sign( )”, a signature verification function “Veri( )”, and a key generation function “Gen( )”. Here, Sign(x,y) is used to sign data y using key data x. Veri(x,y) is used to verify signature data y using key x. Gen(x,y) is used to generate a key by using data x on data y. Furthermore, Gen( ) here satisfies the relation Gen(x,Gen(y,z))=Gen(y,Gen(x,z)). Note that a detailed description of this key generation function, being realizable with arbitrary well-known technology, is not referred to here. An example of such technology is the (DH) public key distribution scheme disclosed in Reference 4 above.

Processing unit 607, on receipt of CRL 507 and an instruction to start authentication from judgment unit 651 in verification unit 607, waits for a CA-issued certificate (hereinafter “Cert_A”) from reading device 700. Here, the public key of device 700, the certificate ID, and the certificate signature for the public key and ID (these being the elements structuring Cert_A) are “PK_A”, “ID_A”, “Sig_CA(SK_CA,PK_A∥ID_A)”, respectively. Note that Sig_CA(A,B) indicates signature data obtained by performing digital signature Sig_CA on data B using key A. Note also that “Sig_CA(SK_CA,PK_A∥ID_A)” is hereinafter written as “Sig_CA A”.

Processing unit 607, on receipt of Cert_A from reading device 700 via IO unit 613, reads the CA public key from PK storage unit 603, and uses the read key in verifying the signature “Sig_CA A” included in Cert_A.

Processing to establish a SAC is ended if judged, as a result of the verification, that the signature “Sig_CA_A” is not authentic.

If judged that Sig_CA_A is authentic, processing unit 607 checks whether ID “ID_A” included in Cert_A is entered in CRL 507 received from judgment unit 651. The processing is ended if ID_A is entered in CRL 507.

If ID_A is not entered in CRL 507, processing unit 607 reads the certificate (hereinafter “Cert_B”) from certificate storage unit 601, and outputs Cert_B to reading device 700. Here, the public key of device 600, the certificate ID, and the certificate signature for the public key and ID (these being the elements structuring Cert_B) are “PK_B”, “ID_B”, “Sig_CA(SK_CA,PK_B∥ID_B)”, respectively. Note that “Sig_CA(SK_CA,PK_B∥ID_B)” is hereinafter written as “Sig_CA_B”.

Processing unit 607, on receipt of a random number “Cha_A” from reading device 700 via IO unit 613, signs Cha_A using the prestored secret key (hereinafter “SK_B”) to generate a signature “Sig_B=Sign(SK_B,Cha_A)”, and outputs the generated signature to device 700 via IO unit 613.

Processing unit 607 also generates a random number “Cha_B” and outputs the generated random number to reading device 700 via IO unit 613. Unit 607 receives from device 700 via IO unit 613 a signature “Sig_A=Sign(SK_A,Cha_B)” generated by signing Cha_B with the secret key “SK_A” held only by device 700, and uses the public key “PK_A” included in the received Cert_A in judging whether Sig_A is authentic. That is, unit 607 judges whether Veri(PK_A,Sig_A) matches Cha_B.

Processing unit 607 ends the processing to establish a SAC if judged that Sig_A is not authentic.

If judged to be authentic, processing unit 607 generates a random number “b”, calculates a key “Key_B=Gen(b,Y)” and outputs the generated key to reading device 700 via IO unit 613.

Processing unit 607 receives from reading device 700 via IO unit 613 a key “Key_A” calculated in device 700. Here, Key_A=Gen(a,Y), where “a” is a random number generated in device 700.

Processing unit 607 derives a shared key “Key AB=Gen (b, Key_A)” shared with reading device 700.

Processing unit 607 outputs the shared key “Key_AB” to 1st decryption unit 608.

(8) 1st Decryption Unit 608

1st decryption unit 608 has a common key (CK) encryption algorithm (e.g. DES algorithm).

1st decryption unit 608, on receipt of a shared key “Key_AB” from processing unit 607, requests reading device 700 via IO unit 613 for a content key.

1st decryption unit 608 receives from reading device 700 via IO unit 613 a double-encrypted content key generated by using the shared key “Key_AB” to encrypt an encrypted content key with the same PK encryption algorithm as that of unit 608.

1st decryption unit 608 uses the shared key “Key_AB” to decrypt the double-encrypted content key with the PK encryption algorithm to generate an encrypted content key, and outputs the generated key to 2nd decryption unit 609.

(9) 2nd Decryption Unit 609

2nd decryption unit 609 has the same CK encryption algorithm as that used to generate encrypted content keys.

2nd decryption unit 609, on receipt of an encrypted content key from 1st decryption unit 608, instructs 3rd decryption unit 610 to acquire a media key.

2nd decryption unit 609, on receipt of a media key from 3rd decryption unit 610, used the media key to decrypt the encrypted content key with the CK encryption algorithm to generate a content key, and outputs the generated content key to 4th decryption unit 611.

(10) 3rd Decryption Unit 610

3rd decryption unit 610 has the same CK encryption algorithm as that used to generate encrypted media keys.

3rd decryption unit 610, when instructed by 2nd decryption unit 609 to acquire a media key, instructs reading device 700 via IO unit 613 to read an encrypted media key, and receives from device 700 via IO unit 613 all of the encrypted media keys recorded on recording medium 500.

3rd decryption unit 610, reads the device key and DK identifier from DK storage unit 602, and uses the DK identifier in acquiring the key from among the encrypted media keys that corresponds to the device key. For example, if the read DK identifier is “2”, unit 610 acquires the encrypted media key “E(DK2,Km)” shown as the second of the encrypted media keys, whereas if the read DK identifier is “10”, unit 610 acquires the encrypted media key “E(DK10,Km)” shown as the tenth of the encrypted media keys.

3rd decryption unit 610 uses the device key to decrypt the acquired key with the CK encryption algorithm to generate a media key, and outputs the generated key to 2nd decryption unit 609.

(11) 4th Decryption Unit 611

4th decryption unit 611 has the same CK encryption algorithm as that used to generate encrypted content.

4th decryption unit 611, on receipt of a content key from 2nd decryption unit 609, instructs reading device 700 via IO unit 613 to read encrypted content, and receives encrypted content via IO unit 613.

4th decryption unit 611 uses the content key to decrypt the encrypted content with the CK encryption algorithm to generate content, and outputs the generated content to output unit 612.

(12) Output Unit 612

Output unit 612, which includes a display and a speaker, for example, outputs content received from 4th decryption unit 611 externally.

(13) IO Unit 613

IO unit 613 performs data input/output between playback device 600 and reading device 700.

2.3 Structure of Reading Device 700

Reading devices 700a, 700b, . . . , 700c, all of which have similar structures, are described here using a single reading device 700. Device 700 is paired with playback device 600.

Reading device 700 is, as shown in FIG. 13, constituted from a CA public key (PK) storage unit 701, a certificate storage unit 702, a verification unit 703, a transmission unit 704, a processing unit 705, an encryption unit 706, a 1st reading unit 707, a 2nd reading unit 708, a 3rd reading unit 709, a 4th reading unit 710, a 1st input/output (IO) unit 711, and a 2nd input/output (IO) unit 712.

Reading device 700 is, specifically, a computer system constituted from a microprocessor, ROM, RAM, a hard disk unit, and the like. The ROM or hard disk unit stores a computer program, and device 700 performs functions as a result of the microprocessor operating in accordance with the computer program.

(1) PK Storage Unit 701

PK storage unit 701 stores a CA public key that corresponds to the secret key (SK_CA) held only by the CA.

(2) Certificate Storage Unit 702

Certificate storage unit 702 stores the certificate of reading device 700.

(3) Verification Unit 703

Verification unit 703 verifies the certificates of playback devices and CRL signatures included in extraction information, checks the version of CRL 506, and assesses the validity of the certificates.

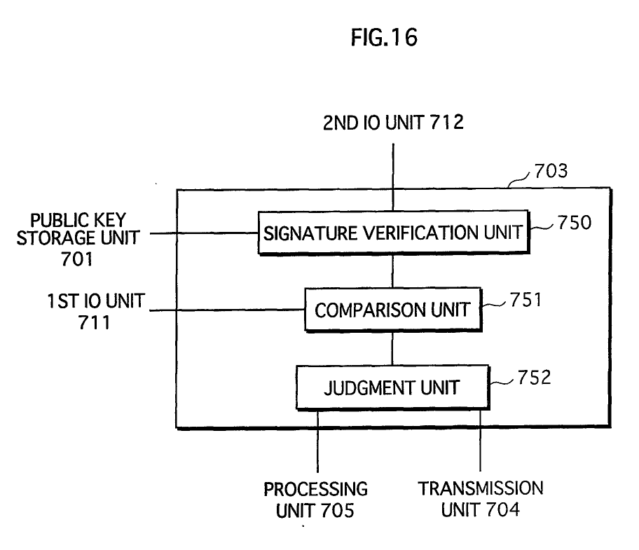

Verification unit 703, as shown in FIG. 16, includes a signature verification unit 750, a comparison unit 751, and a judgment unit 752.

Units 750, 751 and 752 are described below. Signature Verification Unit 750: On receipt of extraction information and a certificate from playback device 600 via 2nd IO unit 712, unit 750 reads the CA public key from PK storage unit 701.

Unit 750 uses the read public key in verifying the certificate and the CRL signature included in the extraction information, and outputs the certificate and extraction information to comparison unit 751 if the authenticity of the certificate and CRL signature is verified.

Comparison Unit 751: Unit 751 is able to access recording medium 500 via 1st IO unit 711.

Unit 751, on receipt of extraction information and a certificate from signature verification unit 750, reads CRL 506 from recording medium 500 via 1st IO unit 711, compares the version number included in CRL 506 with the version number included in the extraction information, and judges whether the version numbers match.

Unit 751 outputs the certificate, extraction information, and CRL 506 to judgment unit 752 if judged that the version numbers match.

Judgment Unit 752: Unit 752 has separate areas for storing a playback device CRL and certificate.

On receipt of CRL 506, extraction information, and a certificate from comparison unit 751, unit 752 uses the extraction information in judging whether the certificate is valid.

If judged that the received certificate is valid, unit 752 instructs transmission unit 704 to output the certificate stored in certificate storage unit 702 to device 600, and stores the received certificate and CRL 506 in the certificate storage area and CRL storage area, respectively.

Note that description of the judgment method, being similar to embodiment 1, is omitted here.

If judged that a received certificate is valid, unit 752 is thus able to determine that playback device 600 is authorized (i.e. a valid device), and if judged that a received certificate is revoked, unit 752 is thus able to determine that playback device 600 is not authorized (i.e. a revoked device).

Consider an example in which the certificate ID is “5” and the ID interval include in the extraction information is “RID2=0003˜RID3=0010”. In this case, since the value “5” belongs to the valid interval, which is “4, 5, 6, 7, 8, 9”, unit 752 judges the certificate to be valid. Consider another example in which the certificate ID is “3” and the ID interval include in the extraction information is “RID2=0003˜RID3=0010”. Here, since the value “3” is not included within the valid interval, which again is “4, 5, 6, 7, 8, 9”, unit 752 judges the certificate to be revoked.

(4) Transmission Unit 704

Transmission unit 704, when instructed by judgment unit 752 in verification unit 703 to output a certificate, reads the certificate from certificate storage unit 702, and outputs the read certificate to playback device 600 via 2nd IO unit 712.

Transmission unit 704 also instructs processing unit 705 to start authentication.

(5) Processing Unit 705

Processing unit 705 performs mutual authentication between reading device 700 and playback device 600 via 2nd IO unit 712, in order to establish a SAC for securely transmitting information over the general communication channel connecting devices 700 and 600.

Processing unit 705 prestores the secret key “SK_A” held only by reading device 700. Unit 705 also prestores a system parameter “Y”, a signature generation function “Sign( )”, a signature verification function “Veri( )”, and a key generation function “Gen( )”, all of which are the same as those prestored by processing unit 607 in playback device 600.

Processing unit 705, when instructed by transmission unit 704 to start authentication, reads the certificate “Cert_A” from certificate storage unit 702, and outputs Cert_A to playback unit 600 via 2nd IO unit 712.

Processing unit 705, on receipt of Cert_B from playback device 600 via 2nd IO unit 712, reads the CA public key from PK storage unit 701, and uses the read key in verifying the signature “Sig_CA_B” included in Cert_B.

Processing to establish a SAC is ended if judged, as a result of the verification, that Sig_CA_B is not authentic.

If judged that Sig_CA_B is authentic, processing unit 705 reads CRL 506 from the CRL storage area of judgment unit 752 in verification unit 703, and checks whether the ID “ID_B” included in Cert_B is entered in CRL 506. The processing is ended if ID_B is entered in CRL 506.

If ID_B is not entered in CRL 506, processing unit 705 generates a random number “Cha_A”, and outputs the generated random number to playback device 600 via IO unit 712.

Processing unit 705, on receipt of a signature “Sig_B” from playback device 600 via IO unit 712, uses the public key “PK_B” included in Cert_B in judging whether Sig_B is authentic. That is, unit 705 judges whether Veri(PK_B, Sig_B) matches Cha_A.

Processing unit 705 ends the processing to establish a SAC if judged that Sig_B is not authentic.

If judged to be authentic, processing unit 705 waits for a random number “Cha_B” from playback device 600.

Processing unit 705, on receipt of Cha_B via 2nd IO unit 712, signs Cha_B using the prestored secret key “SK_A” to generate a signature “Sig_A”, and outputs the generated signature to playback device 600 via 2nd IO unit 712.

Processing unit 705 receives a key “Key_B” from playback device 600 via 2nd IO unit 712.

Processing unit 705 generates a random number “a”, calculates a key “Key_A=Gen(a,Y)” and outputs the generated key to playback device 600 via 2nd IO unit 712.

Processing unit 705 derives a shared key “Key_AB=Gen(a, Key_B)” shared with playback device 600.

Processing unit 705 outputs the shared key “Key_AB” to encryption unit 706.

(6) Encryption Unit 706

Encryption Unit 706 has the same CK encryption algorithm as 1st decryption unit 608 in playback device 600, and is able to access recording medium 500 via 1st IO unit 711.

Encryption unit 706 receives a common key from processing unit 705.

Encryption unit 706, when requested for a content key by 1st decryption unit 608 via 2nd IO unit 712, reads an encrypted content key from recording medium 500 via 1st IO unit 711. Unit 706 uses the common key to encrypt the encrypted content key with the CK encryption algorithm to generate a double-encrypted content key, and outputs the double-encrypted content key to unit 608 via 2nd IO unit 712.

(7) 1st Reading Unit 707

1st reading unit 707 is able to access recording medium 500 via 1st IO unit 711.

1st reading unit 707, on detecting via 1st IO unit 711 that recording medium 500 is mounted in reading device 700, generates detection information, and outputs the generated information to extraction unit 604 via 2nd IO unit 712.

1st reading unit 707, on receipt of a 1st CRL read instruction from extraction unit 604 via 2nd IO unit 712, reads CRL 506 from recording medium 500 via 1st IO unit 711, and outputs the read CRL to extraction unit 604 via 2nd IO unit 712.

(8) 2nd Reading Unit 708

2nd reading unit 708 is able to access recording medium 500 via 1st IO unit 711.

2nd reading unit 708, when instructed by 3rd decryption unit 610 via 2nd IO unit 712 to read an encrypted media key, reads all of the encrypted media keys from recording medium 500 via 1st IO unit 711, and outputs the read keys to unit 610 via 2nd IO unit 712.

(9) 3rd Reading Unit 709

3rd reading unit 709 is able to access recording medium 500 via 1st IO unit 711.

3rd reading unit 709, when instructed by 4th decryption unit 611 via 2nd IO unit 712 to read encrypted content, reads encrypted content from recording medium 500 via 1st IO unit 711, and outputs the encrypted content to unit 611 via 2nd IO unit 712.

(10) 4th Reading Unit 710

4th reading unit 710 is able to access recording medium 500 via 1st IO unit 711.

4th reading unit 710, on receipt of a 2nd CRL read instruction from signature verification unit 650 in verification unit 606 via 2nd IO unit 712, reads CRL 507 from recording medium 500 via 1st IO unit 711, and outputs the read CRL to unit 650 via 2nd IO unit 712.

(11) 1st IO Unit 711

1st IO unit 711 outputs data recorded on recording medium 500 to verification unit 703, encryption unit 706, 1st reading unit 707, 2nd reading unit 708, 3rd reading unit 709, and 4th reading unit 710.

(12) 2nd IO Unit 712

2nd IO unit 712 performs data input/output between reading device 700 and playback device 600.

2.4 Operations of CA Terminal 50

Description of the processing performed by CA terminal 50 to generate and write a playback device CRL, being the same is that performed by CA terminal 10 in embodiment 1, is omitted here.

Description of the processing performed by CA terminal 50 to generate and write a reading device CRL, being the same the prior art, is also omitted here.

2.5 Operations of Playback Device 600 and Reading Device 700

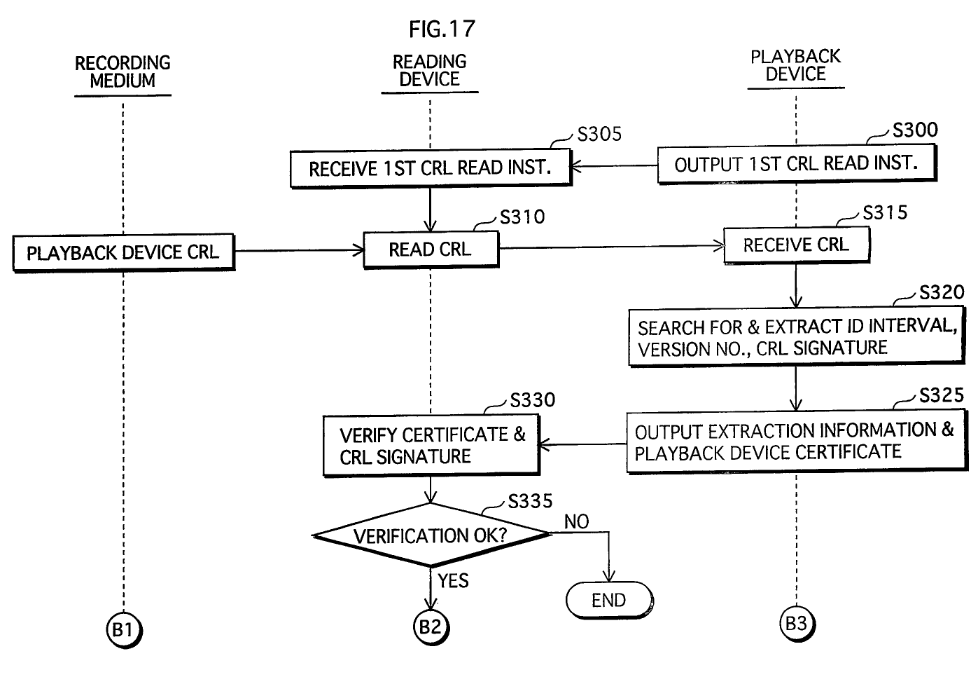

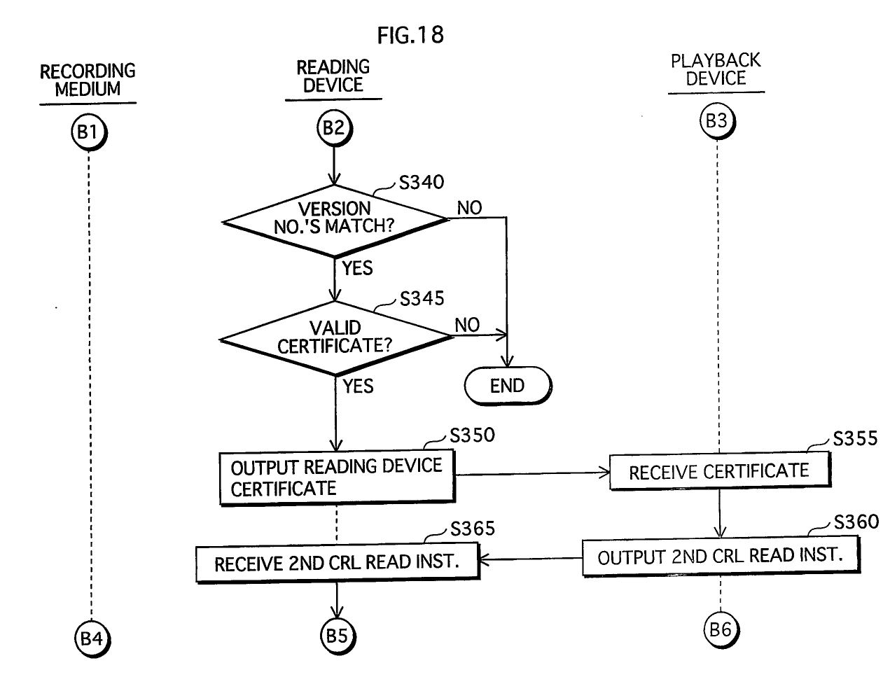

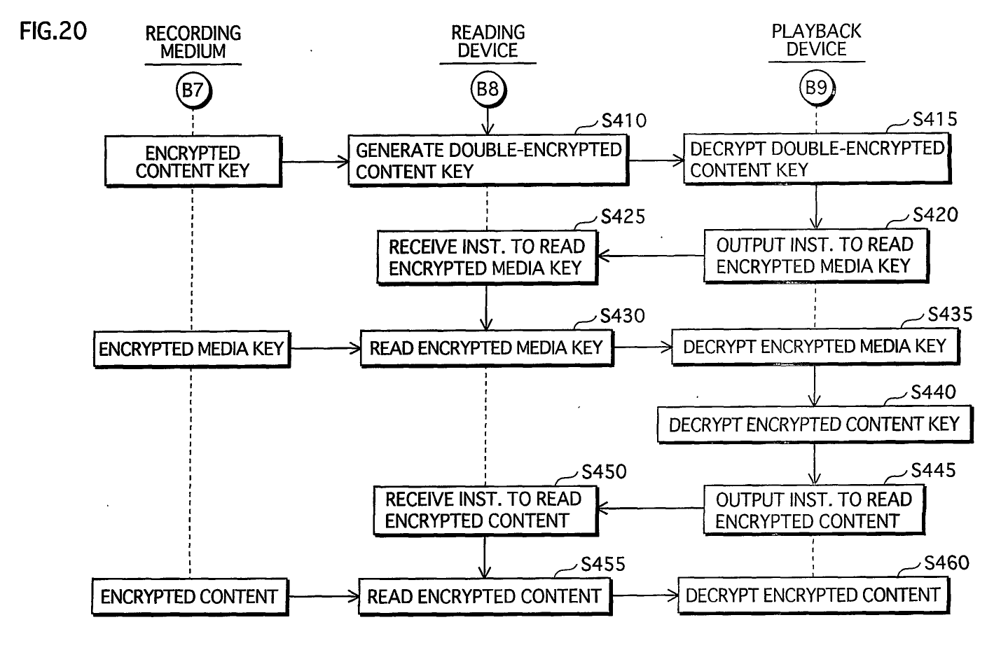

The operations relating to authentication and content playback in playback device 600 and reading device 700 are described here using the flowcharts shown in FIGS. 17, 18, 19 and 20.

Extraction unit 604 in playback device 600, on receipt of detection information from 1st reading unit 707 in reading device 700, outputs a 1st CRL read instruction to unit 707 via IO unit 613 (step S300).

1st reading unit 707, on receipt of the instruction from extraction unit 604 via 2nd IO unit 712 (step S305), reads CRL 506 from recording medium 500 via 1st IO unit 711, and outputs the read CRL to unit 604 via 2nd IO unit 712 (step S310).

Extraction unit 604, on receipt of CRL 506 via IO unit 613 (step S315), reads the certificate from certificate storage unit 601, and, using the read certificate, searches for and extracts from CRL 506 the version number, an interval corresponding to the ID included in the read certificate, and the CRL signature for the version number and interval (step S320).

Extraction unit 604 generates extraction information constituted from the extracted version number, ID interval and CRL signature, and outputs the generated information to transmission unit 605, which then reads the certificate from certificate storage unit 601, and outputs the certificate and extraction information to verification unit 703 via IO unit 613 (step S325).

Signature verification unit 750 in verification unit 703, on receipt of the certificate and extraction information via 2nd IO unit 712, reads the CA public key from PK storage unit 701, and uses the read key in verifying the certificate and the CRL signature included in the extraction information (step S330). Unit 750 determines whether the certificate and CRL signature are authentic depending on the verification result (step S335).

If the certificate and CRL signature are judged to be authentic (step S335=YES), signature verification unit 750 outputs the certificate and extraction information to comparison unit 751, which then reads CRL 506 from recording medium 500 via 1st IO unit 711, and compares the version number included in CRL 506 with the version number included in the extraction information, and judges whether the version numbers match (step S340).

If judged in the affirmative (step S340=YES), comparison unit 751 outputs CRL 506, the certificate, and the extraction information to judgment unit 752, which uses the received extraction information in judging whether the certificate is valid (step S345).

If judged to be valid (step S345=YES), judgment unit 752 instructs transmission unit 704 to output a certificate, and stores the received certificate and CRL 506 in the certificate and CRL storage areas, respectively. Unit 704, in response to the instruction from unit 752, reads the certificate stored in certificate storage unit 702, outputs the read certificate to playback device 600 via 2nd IO unit 712, and instructs processing unit 705 to start authentication (step S350).

The processing is ended if judged that the certificate is not authentic (step S335=NO), the version numbers do not match (step S340=NO), or the certificate is revoked (step S345=NO).

Signature verification unit 650 in verification unit 606, on receipt of the certificate from reading device 700 via IO unit 613, outputs a 2nd CRL read instruction to 4th reading unit 710 via IO unit 613 (step S360).

4th reading unit 710, on receipt of the instruction from signature verification unit 650 via 2nd IO unit 712 (step S365), reads CRL 507 from recording medium 500 via 1st IO unit 711, and outputs the read CRL to unit 650 via 2nd IO unit 712 (step S370).

Signature verification unit 650, on receipt of CRL 507 via IO unit 613, reads the CA public key from PK storage unit 603, and uses the read key in verifying the certificate and the CRL signature included in CRL 507 (step S375). Unit 650 determines whether the certificate and CRL signature are authentic depending on the verification result (step S380).

If the certificate and CRL signature are judged to be authentic (step S380=YES), signature verification unit 650 outputs the certificate and CRL 507 to judgment unit 651, which uses the received certificate and CRL 507 in judging whether the certificate is valid (step S385).

If judged to be valid (step S385=YES), judgment unit 651 instructs processing unit 607 to start mutual authentication. In response, unit 607 performs SAC processing with processing unit 705 in reading device 700 (steps S390/S395).

The processing is ended if judged that the certificate is not authentic (step S380=NO) or the certificate is not valid (step S385=NO).

If a SAC is established at steps S390/S395, 1st decryption unit 608 requests encryption unit 706 via IO unit 613 for a content key (step S400).

Encryption unit 706, on receipt of the request from 1st decryption unit 608 via 2nd IO unit 712 (step S405), reads an encrypted content key from recording medium 500 via 1st IO unit 711, uses the shared key received from processing unit 705 to encrypt the encrypted content key with the CK encryption algorithm to generate a double-encrypted content key, and outputs the double-encrypted content key to unit 608 via 2nd IO unit 712 (step S410).

1st decryption unit 608, on receipt of the double-encrypted content key via IO unit 613, uses the shared key received from processing unit 607 to decrypt the double-encrypted content key with the CK encryption algorithm to generate an encrypted content key, and outputs the generated key to 2nd decryption unit 609 (step S415).

2nd decryption unit 609, on receipt of the encrypted content key, instructs 3rd decryption unit 610 to acquire a media key. In response, unit 610 instructs 2nd reading unit 708 via IO unit 613 to read an encrypted media key (step S420).

2nd reading unit 708, on receipt of the instruction from 3rd decryption unit 610 via 2nd IO unit 712 (step S425), reads all of the encrypted media keys from recording medium 500 via 1st IO unit 711, and outputs the read keys to unit 610 via 2nd IO unit 712 (step S430).

3rd decryption unit 610, on receipt of the encrypted media keys via IO unit 613, reads the device key and DK identifier from DK storage unit 602, and uses the DK identifier in acquiring the key from among the encrypted media keys that corresponds to the device key, uses the device key to decrypt the acquired key with the CK encryption algorithm to generate a media key, and outputs the generated key to 2nd decryption unit 609 (step S435).

2nd decryption unit 609, on receipt of the media key, uses the received key to decrypt the encrypted content key with the CK encryption algorithm to generated a content key, and outputs the generated key to 4th decryption unit 611 (step S440), which then instructs 3rd reading unit 709 via IO unit 613 to read encrypted content (step S445).

3rd reading unit 709, on receipt of the instruction from 4th decryption unit 611 via 2nd IO unit 712 (step S450), reads encrypted content from recording medium 500 via 1st IO unit 711, and outputs the encrypted content to unit 611 via 2nd IO unit 712 (step S455).

4th decryption unit 611, on receipt of the encrypted content via IO unit 613, uses the content key to decrypt the encrypted content with the CK encryption algorithm to generate content, and outputs the generated content to output unit 612, which outputs the received content externally (step S460).

2.6 SAC Processing

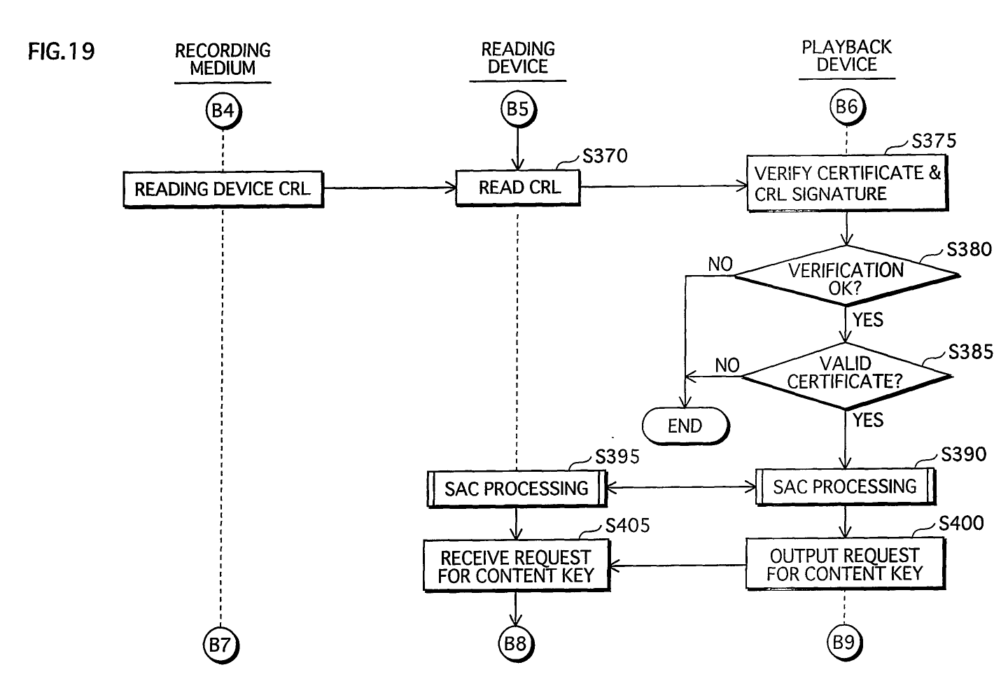

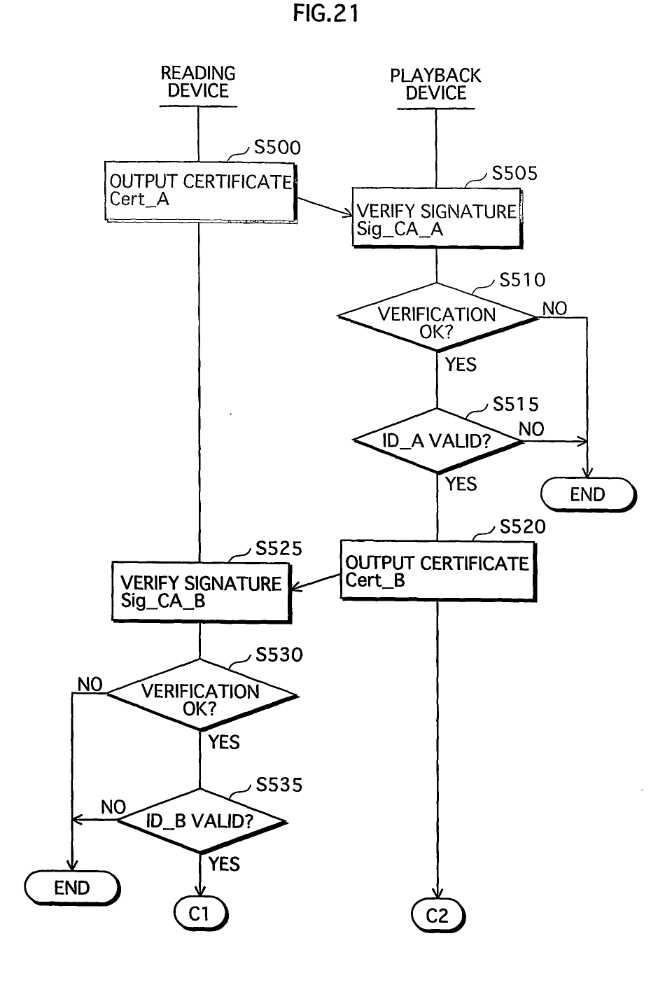

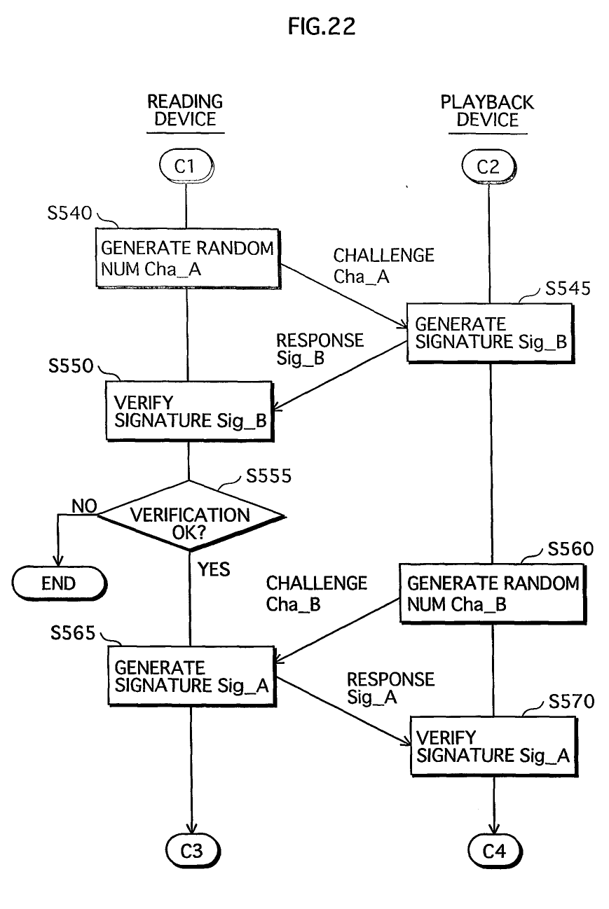

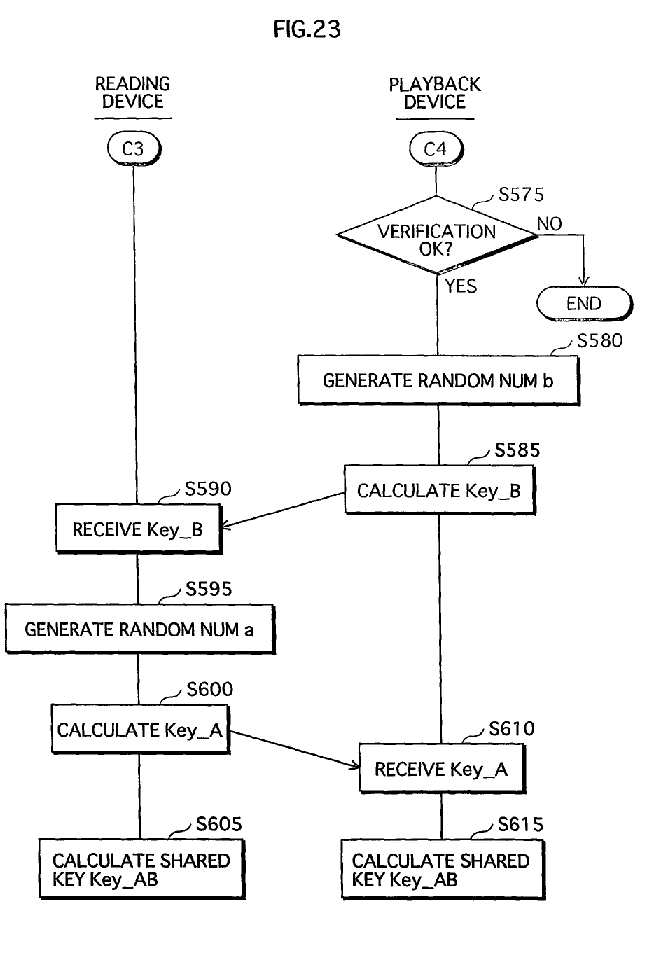

The SAC processing shown in FIG. 19 is described here using the flowcharts shown in FIGS. 21, 22 and 23.

Processing unit 705 in reading device 700, when instructed by transmission unit 704 to start authentication, reads the certificate “Cert_A” from certificate storage unit 702, and outputs the read certificate to processing unit 607 in reading device 600 via 2nd IO unit 712 (step S500).

Processing unit 607, on receipt of CRL 507 and an authentication start instruction from judgment unit 651, waits for Cert_A. On receipt of Cert_A via IO unit 613, unit 607 read the CA public key from PK storage unit 603, and uses the read key in verifying the signature “Sig_CA_A” included in Cert_A (step S505).

Processing unit 607 judges whether Sig_CA_A is authentic depending on the verification result (step S510).

Processing unit 607 ends the SAC processing if judged that Sig_CA_A is not authentic (step S510=NO).

If judged to be authentic (step S510=YES), processing unit 607 checks at step S515 whether the ID “ID_A” included in Cert_A is entered in CRL 507 (i.e. judges whether ID_A is valid or revoked), and ends the SAC processing if judged to be entered (step S515=NO).

If not entered (step S515=YES), processing unit 607 reads the certificate “Cert_B” from certificate storage unit 601, and outputs the read certificate to processing unit 705 via IO unit 613 (step S520).

Processing unit 705, on receipt of Cert_B via 2nd IO unit 712, reads the CA public key from PK storage unit 701, and uses the read key in verifying the signature “Sig_CA_B” included in Cert_B (step S525).

Processing unit 705 judges whether Sig_CA_B is authentic depending on the verification result (step S530).

Processing unit 705 ends the SAC processing if judged that Sig_CA_B is not authentic (step S530=NO).

If judged to be authentic (step S530=YES), processing unit 705 reads CRL 506 from the CRL storage area in judgment unit 752, checks at step S535 whether the ID “ID_B” included in Cert_B is entered in CRL 506 (i.e. judges whether ID_B is valid or revoked), and ends the SAC processing if judged to be entered (step S535=NO).

If not entered (step S535=YES), processing unit 705 generates a random number “Cha_A” and outputs the generated random number to processing unit 607 via 2nd IO unit 712 (step S540).

Processing unit 607, on receipt of Cha_A via IO unit 613, generates a signature “Sig_B=Sign(SK_B,Cha_A)” by using the secret key “SK_B” to sign Cha_A, and outputs the generated signature to processing unit 705 via IO unit 613 (step S545). Unit 607 also generates a random number “Cha_B” and outputs the generated random number to unit 705 via IO unit 613 (step S560).

Processing unit 705, on receipt of Sig_B via 2nd IO unit 712, uses the public key “PK_B” included in Cert_B in verifying Sig_B (step S550). Unit 705 judges whether Sig_B is authentic depending on the verification result (step S555).

Processing unit 705 ends the SAC processing if judged that Sig_B is not authentic (step S555=NO).

If judged to be authentic (step S555=YES), processing unit 705 receives the random number “Cha_B” from processing unit 607 via 2nd IO unit 712, and generates a signature “Sig_A=Sign(SK_A,Cha_B)” by using the secret key “SK_A” to sign Cha_B, and outputs the generated signature to processing unit 607 via 2nd IO unit 712 (step S565).

Processing unit 607, on receipt of Sig_A via IO unit 613, uses the public key “PK_A” included in Cert_A in verifying Sig_A (step S570). Unit 607 judges whether Sig_A is authentic depending on the verification result (step S575).

Processing unit 607 ends the SAC processing if judged that Sig_A is not authentic (step S575=NO).

If judged to be authentic (step S575=YES), processing unit 607 generates a random number “b” (step S580), calculates a key “Key_B=Gen(b,Y)”, and outputs the generated key to processing unit 705 via IO unit 613 (step S585).

Processing unit 705 receives Key_B via 2nd IO unit 712 (step S590).

Processing unit 705 generates a random number “a” (step S595), calculates a key “Key_A=Gen(a,Y)”, and outputs the generated key to processing unit 607 via 2nd IO unit 712 (step S600).

Processing unit 705 derives a shared key “Key_AB=Gen(a,Key_B)” and outputs the derived key to encryption unit 706 (step S605).

Processing unit 607 receives Key_A via IO unit 613 (step S610).

Processing unit 607 derives a shared key “Key_AB=Gen(b,Key_A)” and outputs the derived key to 1st decryption unit 608 (step S615).

3. Variations

Present invention, described above based on the preferred embodiments 1 and 2, is of course not limited to these embodiments. The following variations are also included therein.

(1) The data format of a playback device CRL is not limited to that shown in embodiments 1 and 2. The data format need not include dummy IDs (i.e. “0000” “9999” in above embodiments).

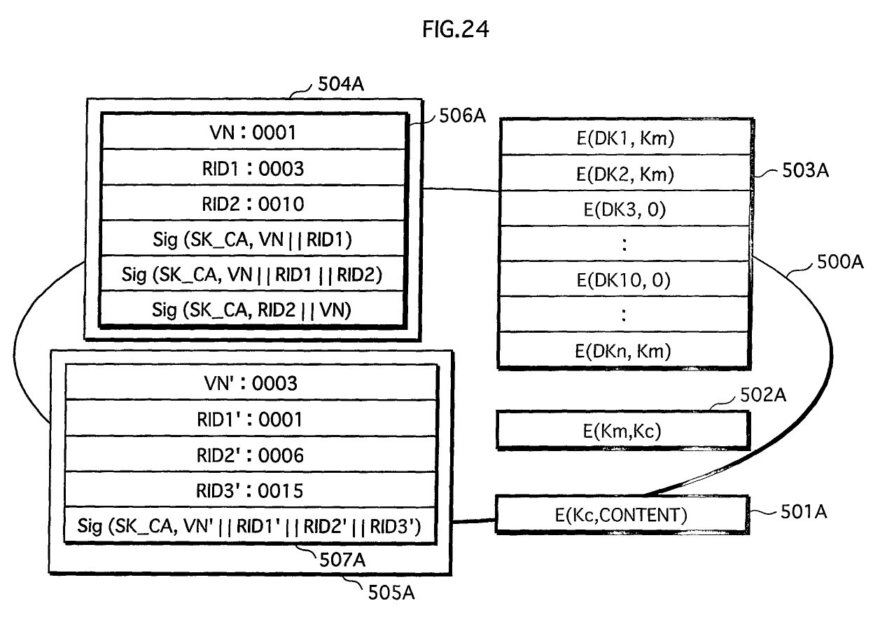

An exemplary data format according to this variation is shown in FIG. 24 as a variation of embodiment 2. A recording medium 500A is constituted from a content storage area 501A, a content key (CK) storage area 502A, a media key (MK) storage area 503A, a 1st CRL storage area 504A, and a 2nd CRL storage area 505A. Description of areas 501A, 502A and 503A, being similar to areas 501, 502 and 503 in recording medium 500, is omitted here. Description of area 505A, which stores a reading device CRL 507A, and CRL 507A, which is similar to CRL 507, is also omitted here.

1st CRL storage area 504A stores a CRL 506A relating to playback devices. While CRL 506A is constituted from the same elements as CRL 506, the non-provision of dummy IDs when recording RIDs means that the content of the first and last CRL signatures in CRL 506A differs from that of CRL 506. The head CRL signature is provided for a value obtained by concatenating the version number and the head RID in the stated order, while the final CRL signature is provided for a value obtained by concatenating the final RID and the version number in the stated order. CRL signatures for RIDs positioned between the first and last RIDs are provided as described in embodiments 1 and 2.

FIG. 24 illustrates an example in which certificates having the IDs “3” and “10” are revoked. The number of CRL signatures in this case is three, the first being “Sig(SK_CA,VN∥RID1)” provided for a value obtained by concatenating the version number and the head RID, the second being “Sig(SK_CA,VN∥RID1∥RID2)” provided for a value obtained by concatenating the version number and the ID interval, and the third being “Sig(SK_CA,RID2∥VN)” provided for a value obtained by concatenating the version number and the last RID.

Firstly, CA terminal 50A for generating CRL 506A is described.

Note that the playback device CRL stored in CA terminal 50A prior to generating CRL 506A is referred to here as the pre-update CRL.

CA terminal 50A is constituted from a common key (CK) storage unit 51A, a CRL storage unit 52A, a reception unit 53A, a CRL generation unit 54A, and a writing unit 55A.

CA terminal 50A is, specifically, a computer system constituted from a microprocessor, ROM, RAM, a hard disk unit, and the like. The ROM or hard disk unit stores a computer program, and CA terminal 50A performs functions as a result of the microprocessor operating in accordance with the computer program.

SK Storage Unit 51A: Unit 51A securely stores a secret key (SK_CA) held only by the CA, in a state in which external access is not possible.

CRL Storage Unit 52A: Unit 52A stores a playback device CRL generated in CA terminal 50A.

Reception Unit 53A: On receipt of a CRL generation instruction and the IDs of all revoked certificates from an authorized user of CA terminal 50A, unit 53A outputs a CRL generation instruction and the received IDs to CRL generation unit 54A.

When instructed by an authorized user of CA terminal 50A to write the CRL stored in CRL storage unit 52A to recording medium 500A, unit 53A instructs writing unit 55A to write the CRL to recording medium 500A.

CRL Generation Unit 54A: Unit 54A has a temporary storage area for temporarily storing a CRL generated by unit 54A.

On receipt from reception unit 53A of a CRL generation instruction and the IDs of all revoked certificates, unit 54A reads all of the RIDs recorded in the pre-update CRL, uses the received IDs and read RIDs to arrange the IDs in ascending order, and stores the arranged IDs in the temporary storage area. The effect of this is to arrange the post-update RIDs in ascending order.

Unit 54A also acquires the version number from the pre-update CRL, adds “1” to the acquired number to update the version number, and stores the updated version number in the temporary storage area.

Unit 54A reads the secret key from SK storage unit 51A, and reads the first of the plurality of RIDs (=“m”, where m≧1) stored in the temporary storage area, and concatenates the version number and the read RID in the stated order. Unit 54A uses the read secret key to generate a CRL signature for the concatenated value, and stores the generated CRL signature in the temporary storage area.

Unit 54A then reads the 2^{nd}/3^{rd} RIDs stored in the temporary storage area, concatenates the version number and the read RIDs in the stated order, uses the read secret key to generate a CRL signature for the concatenated value, and stores the generated CRL signature in the temporary storage area. Unit 54A repeats this operation until the CRL signature for a value obtained by concatenating the version number with the m−1^{th}/m^{th} RIDs has been generated and stored in the temporary storage area.

Next, unit 54A reads the m^{th} RID, concatenates the read RID and the version number in the stated order, uses the read secret key to generate a CRL signature for the concatenated value, and stores the generated CRL signature in the temporary storage area.

Unit 54A then updates the content of the pre-update CRL stored in CRL storage unit 52A to the content stored in the temporary storage area.

As a result, CA terminal 50A stores CRL 506A for writing to recording medium 500A.

Writing Unit 55A: When instructed by reception unit 53A to write a CRL, unit 55A reads the CRL stored in CRL storage unit 52A and writes the read CRL to recording medium 500A.

The following description relates to a playback device 600A.

Playback device 600A is constituted from a certificate storage unit 601A, a device key (DK) storage unit 602A, a CA public key (PK) storage unit 603A, an extraction unit 604A, a transmission unit 605A, a verification unit 606A, a processing unit 607A, a 1st decryption unit 608A, a 2nd decryption unit 609A, a 3rd decryption unit 610A, a 4th decryption unit 611A, an output unit 612A, and an input/output (IO) unit 613A.

Playback device 600A is, specifically, a computer system constituted from a microprocessor, ROM, RAM, a hard disk unit, and the like. The ROM or hard disk unit stores a computer program, and device 600A performs functions as a result of the microprocessor operating in accordance with the computer program.

Note that description of certificate storage unit 601A, DK storage unit 602A, PK storage unit 603A, verification unit 606A, processing unit 607A, 1st decryption unit 608A, 2nd decryption unit 609A, 3rd decryption unit 610A, 4th decryption unit 611A, output unit 612A, and IO unit 613A, being similar, respectively, to units 601, 602, 603, 606, 607, 608, 609, 610, 611, 612, 613 in embodiment 2, is omitted here.

Extraction Unit 604A: Unit 604A instructs a reading device 700A via IO unit 613A to read a CRL, and receives CRL 506A via IO unit 613A.

On receipt of CRL 506A, unit 604A reads the certificate from certificate storage unit 601A, and, using the read certificate, searches for and extracts from CRL 506A the version number, an interval corresponding to the ID included in the read certificate, and the CRL signature for the version number and interval. Here, if the ID included in the read certificate is less than or equal to the value of the head RID included in CRL 506A, unit 604A extracts only the head RID as the ID interval, and if greater than or equal to the value of the last RID, unit 604A extracts only the final RID. In all other cases unit 604 extracts an ID interval per embodiments 1 and 2.

Unit 604A generates extraction information constituted from the extracted version number, ID interval and CRL signature, and outputs the generated information to transmission unit 605A.

Here, if the ID interval included in the extraction information is formed from only the head RID, extraction unit 604A outputs first information to transmission unit 605A indicating that the ID included in the certificate is prior to the head RID, and if the ID interval is formed from only the last RID, unit 604A outputs second information to unit 605A indicating that the ID included in the certificate is subsequent to the last RID.

Transmission Unit 605A: On receipt of extraction information from extraction unit 604A, unit 605A reads the certificate from certificate storage unit 601A, and outputs the certificate and extraction information to reading device 700A via IO unit 613A.

On receipt of first information from extraction unit 604A, unit 605A outputs the received information to reading device 700A via IO unit 613A.

On receipt of second information from extraction unit 604A, unit 605A outputs the received information to reading device 700A via IO unit 613A.

The following description relates to reading device 700A.

Reading device 700A is constituted from a CA public key (PK) storage unit 701A, a certificate storage unit 702A, a verification unit 703A, a transmission unit 704A, a processing unit 705A, an encryption unit 706A, a 1st reading unit 707A, a 2nd reading unit 708A, a 3rd reading unit 709A, a 4th reading unit 710A, a 1st input/output (IO) unit 711A, and a 2nd input/output (IO) unit 712A.

Reading device 700A is, specifically, a computer system constituted from a microprocessor, ROM, RAM, a hard disk unit, and the like. The ROM or hard disk unit stores a computer program, and device 700A performs functions as a result of the microprocessor operating in accordance with the computer program.

Note that description of PK storage unit 701A, certificate storage unit 702A, transmission unit 704A, processing unit 705A, encryption unit 706A, 1st reading unit 707A, 2nd reading unit 708A, 3rd reading unit 709A, 4th reading unit 710A, 1st IO unit 711A, and 2nd IO unit 712A, being similar, respectively, to units 701, 702, 704, 705, 706, 707, 708, 709, 710, 711 and 712 in embodiment 2, is omitted here.

Verification Unit 703A: Unit 703A includes a signature verification unit 750A, a comparison unit 751A, and a judgment unit 752A.

Signature verification unit 750A receives extraction information and a certificate from playback device 600A via 2nd IO unit 712A. Unit 750A receives, from device 600A via 2nd IO unit 712A, first information if the ID interval included in the extraction information is formed only from the head RID, and second information if the ID interval is formed only from the last RID.

On receipt of extraction information and a certificate, unit 750A reads the CA public key from PK storage unit 701A.

Unit 750A uses the read key in verifying the certificate and the CRL signature included in the extraction information.

If the authenticity of the certificate and the CRL signature is verified, unit 750A outputs the certificate and extraction information to comparison unit 751A. Unit 750A also output first and second information to unit 751A if received.

An exemplary method of signature verification is illustrated here. On receipt of first information, signature verification unit 750A uses the CA public key to decrypt the CRL signature and generate a value consisting of the version number and head RID concatenated in the stated order. Unit 750A concatenates the version number and head RID included in the extraction information in the stated order, and verifies the CRL signature by judging whether the resultant value matches the value generated by decrypting CRL signature.

On receipt of second information, signature verification unit 750A uses the CA public key to decrypt the CRL signature and generate a value consisting of the last RID and version number concatenated in the stated order. Unit 750A concatenates, in the stated order, the last RID and version number included in the extraction information, and verifies the CRL signature by judging whether the resultant value matches the value generated by decrypting CRL signature.

If neither the first nor second information is received, signature verification unit 750A uses the CA public key to decrypt the CRL signature and generate a value consisting of the version number and the first and last RIDs in the ID interval concatenated in the stated order. Unit 750A concatenates the version number and the first and last RIDs in the ID interval included in the extraction information in the stated order, and verifies the CRL signature by judging whether the resultant value matches the value generated by decrypting CRL signature.

Comparison unit 751A is able to access recording medium 500A via 1st IO unit 711A.

Unit 751A, on receipt of extraction information and a certificate from signature verification unit 750A, reads CRL 506A from recording medium 500A via 1st IO unit 711A, compares the version number included in CRL 506A with the version number included in the extraction information, and judges whether the version numbers match.

Unit 751A outputs the certificate, extraction information and CRL 506A to judgment unit 752A if judged that the version numbers match. Unit 751A also outputs first and second information to judgment unit 752A if received.

Judgment unit 752A has separate areas for storing a playback device CRL and certificate.

On receipt of CRL 506A, extraction information, and a certificate from comparison unit 751A, unit 752A uses the extraction information in judging whether the certificate is valid.

If judged that the received certificate is valid, judgment unit 752A instructs transmission unit 704A to output the certificate stored in certificate storage unit 702A to device 600A, and stores the received certificate and CRL 506A in the certificate storage area and CRL storage area, respectively.

The judgment method is as follows.

If first information is received from comparison unit 751A, judgment unit 752A judges whether the ID included in the certificate is smaller than the value of the ID interval (i.e. head RID) included in the extraction information. If judged to be smaller, unit 752A determines the certificate to be valid. If not smaller (i.e. the ID included in the certificate equals the value of the head RID), unit 752A determines the certificate to be revoked.

If second information is received from comparison unit 751A, judgment unit 752A judges whether the ID included in the certificate is larger than the value of the ID interval (i.e. last RID) included in the extraction information. If judged to be larger, unit 752A determines the certificate to be valid. If not larger (i.e. the ID included in the certificate equals the value of the last RID), unit 752A determines the certificate to be revoked.

Since the judging process when first or second information is not being received is the same as embodiments 1 and 2, related description is omitted here.

(2) The present invention is not limited to a playback device CRL being used when a reading device authenticates a playback device, as in embodiments 1 and 2. A list of the IDs of valid certificates (hereinafter “certificate validation list” or simply “CVL”), rather than a list of revoked certificate IDs, may be used in authentication.

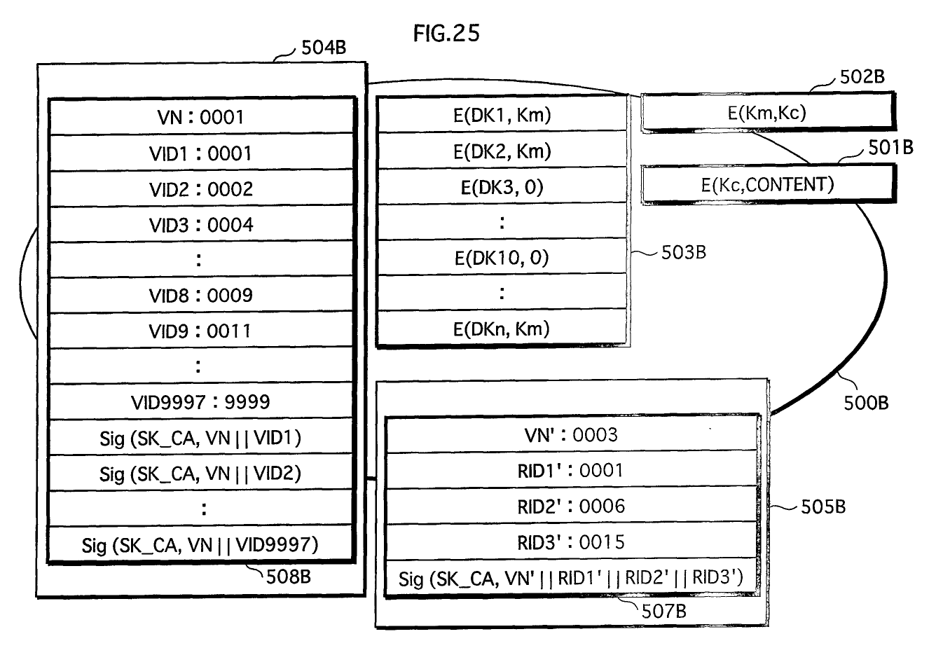

An exemplary CVL is shown in FIG. 25 as a variation of embodiment 2. Recording medium 500B is constituted from a content storage area 501B, a content key (CK) storage area 502B, a media key (MK) storage area 503B, a 1st CRL storage area 504B and a 2nd CRL storage area 505B. Description of areas 501B, 502B and 503B, being similar to areas 501, 502 and 503 of recording medium 500 in embodiment 2, is omitted here. Description of area 505B, which stores a reading device CRL 507B, and CRL 507B, which is similar to CRL 507, is omitted here.

1st CRL storage area 504B stores a CVL 508B relating to playback devices. CVL 508B is constituted from areas storing, respectively, the version number (VN) of the CVL, one or more valid certificate IDs (VIDs), and one or more CVL signatures, which are CA signatures certifying the authenticity of the version number and VIDs.

FIG. 25 shows an example in which certificates other than those having the IDs “3” and “10” are valid; that is, certificates having the IDs “3” and “10” are shown to be revoked. The version number is a value incremented by “1” whenever CVL 508B is updated. CVL signatures are provided for values obtained by concatenating the version number and valid certificate IDs.

Playback device 600B, on receipt of CVL 508B via reading device 700B, reads the certificate of device 600B, and uses the read certificate in judging whether a VID matching the ID included in the read certificate exists in CVL 508B. If there is a match, device 600B search for and extracts from CVL 508B the version number, the VID matching the ID included in the certificate, and the CVL signature for the version number and matching VID, and outputs the certificate and extraction information formed from the version number, VID and CVL signature to device 700B. Device 600B terminates the processing if a VID matching the ID in the read certificate does not exist in CVL 508B.

Reading device 700B uses the extraction information and certificate received from playback device 600B in signature verification, checks the version number as described above if the authenticity of the certificate and the CVL signature included in the extraction information is verified, and judges whether the VID included in the extraction information matches the ID included in the certificate if the version numbers match. Device 700B judges the certificate to be valid if the VID and ID match, and revoked if not matched.

In an initial state, the CVL in CA terminal 50B includes all the certificates issued for playback devices. Every time the ID of a revoked playback device certificate is received, the VID in the CVL corresponding to the received ID is removed from the list.

(3) The recording medium on which encrypted content is prerecorded is not limited to being a prerecorded medium (e.g. DVD-Video), as in embodiments 1 and 2.

The recording medium may be a recordable medium (e.g. DVD-RAM).

In this case, the playback device records the encrypted content via the reading device after the authentication process, as in embodiments 1 and 2.

Here, data for recording is not limited to encrypted content. Other data may be recorded.

(4) The present invention is not limited to data used in authentication, encrypted content, and a key for decrypting encrypted content being recorded on a recording medium, as in embodiments 1 and 2.

Instead of a recording medium, the above data, encrypted content and key may be sent and received using a communication medium.

Alternatively, a combination of the recording and communication media may be employed.

(5) The present invention is not limited to the use of a CA signature to protect data used in the authentication process.

For example, an authenticator (e.g. message authentication code or “MAC”) may be provided for this data.

An exemplary configuration is given here as a variation of embodiment 2.

A CA terminal 50C and a playback device 600C each hold a common secret key (hereinafter, “playback device key” or simply “PD key”). Also, CA terminal 50C and a reading device 700C each hold a common secret key (hereinafter, “reading device key” or simply “RD key”)

When generating a playback device CRL, CA terminal 50C using the RD key (i.e. not the secret key (SK_CA) held by the CA), a plurality of RIDs, and the version number to generate CRL signatures for the version number and RIDs.

When generating a reading device CRL, CA terminal 50C using the PD key (i.e. not the secret key (SK_CA) held by the CA), a plurality of RIDs, and the version number to generate CRL signatures for the version number and RIDs.

Playback device 600C uses the PD key when verifying CRL signatures in a reading device CRL. This is because of the CRL signatures having been generated using the PD key.

Reading device 700C uses the RD key when verifying CRL signatures extracted from a playback device CRL and included in extraction information. This is because of the CRL signatures having been generated using the RD key.

(6) The present invention is not limited to CA terminal 10 writing a playback device CRL to recording medium 100, as in embodiment 1.

CA terminal 10 may update the CRL, distribute the updated CRL to the manufacturer of recording medium 100, and the manufacture may write the CRL to medium 100 during the manufacturing process.

(7) The present invention is not limited to CA terminal 50 writing a playback device CRL and a reading device CRL to recording medium 500, as in embodiment 2.

CA terminal 50 may update the CRLs, distribute the updated CRLs to the manufacturer of recording medium 500, and the manufacture may write the CRLs to medium 500 during the manufacturing process.

(8) The present invention is not limited to a configuration in which no other RIDs exist in the intervals defined by two RIDs in a playback device CRL, as in embodiments 1 and 2.

Other RIDs may exist in an interval defined by two RIDs.

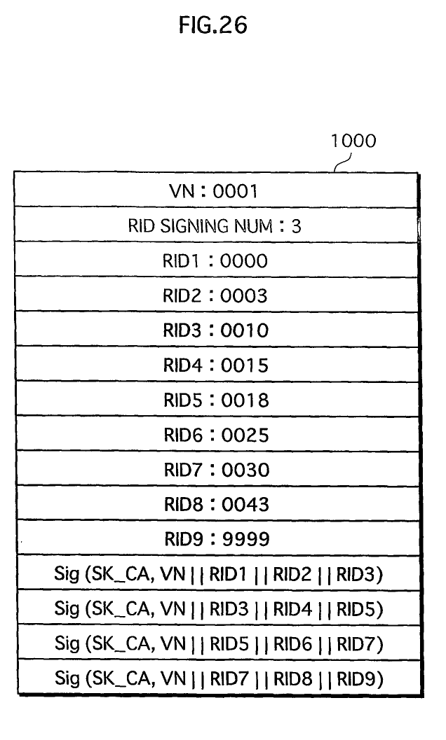

FIG. 26 shows an exemplary CRL 1000 according to this variation.

CRL 1000 is constituted from areas storing, respectively, the version number (VN) of the CRL, a RID signing number, a plurality of revoked certificate IDs (RID), and one or more signatures certifying the authenticity of the version number and RIDs. Each CRL signature is signature data generated by performing a digital signature using the secret key (SK_CA) held only by the CA. Digital signatures that use an RSA cryptosystem employing hash functions are one example.

As shown in FIG. 26, IDs “0000” and “9999” not allocated to actual certificates are also recorded in CRL 1000. The version number is a value incremented by “1” whenever CRL 1000 is updated. The RID signing number (here, given as “3”) shows the number of RIDs to be signed together with the version number. CRL signatures are provided for values obtained by concatenating the version number with the number of RIDs shown by the RID signing number.

The RIDs are recorded in CRL 1000 in ascending order, and the CRL signatures are recorded in CRL 1000 so that the groups of three IDs signed along with the version number are arranged in ascending order. In FIG. 26, for example, the ID groups for signing, when enumerated in ascending order, are “RID1, RID2 and RID3”, “RID3 and RID4 and RID5”, and “RID5, RID6 and RID7”, and “RID7, RID8 and RID9”. These groupings are signed together with the version number in this order using the CA's secret key (SK_CA) to generate CRL signatures, which are then recorded in CRL 1000.

The initial state of CRL 1000 is, for example, constituted from a version number “0000”, a RID signing number “3”, two RIDs “0000” and “9999”, and a single CRL signature “Sig(SK_CA,0000∥0000∥9999)”.

CA Terminal: Described here is the generation and writing of CRL 1000 to a recording medium performed in a CA terminal according to the present variation.

The CA terminal prestores the secret key (SK_CA) and a RID signing number, and has a temporary storage area for temporarily storing CRL 1000 generated in the CA terminal. The CA terminal also stores a pre-update CRL (i.e. CRL prior to generating CRL 1000).

The CA terminal, on receipt of a CRL generation instruction and the IDs of all revoked certificates from an authorized user of the CA terminal, reads all of the RIDs recorded in the pre-update CRL, uses the received IDs and read RIDs to arrange the IDs in ascending order, and stores the arranged IDs in the temporary storage area. The effect of this is to arrange the post-update RIDs in ascending order.

The CA terminal acquires the version number from the pre-update CRL, adds “1” to the acquired number to update the version number, and stores the updated version number in the temporary storage area.

The CA terminal stores the prerecorded RID signing number in the temporary storage area.

The CA terminal uses the secret key (SK_CA), the version number, and the plurality of RIDs stored in the temporary storage area to generate CRL signatures for the version number and RID groupings based on the RID signing number, stores the generated CRL signatures in the temporary storage area, and generates a playback device CRL for recording to a recording medium.

The CA terminal, having generated and stored the CRL signatures in the temporary storage area, updates the content of the pre-update CRL to the content stored in the temporary storage area.

The CA terminal, when instructed by an authorized user of the CA terminal to write CRL 1000 to a recording medium, read the stored CRL 1000 and writes the read CRL to a recording medium.

The following description relates to the generation of CRL signatures.

Here, the number of revoked IDs stored in the temporary storage area (i.e. the number of RIDs) is given as “m” (m≧2). The RIDs stored in the temporary storage area, in ascending order of the ID values, are referred to as the 1^{st} RID, 2^{nd} RID, . . . m^{th} RID.

The CA terminal reads the prestored secret key (SK_CA).

The CA terminal reads the version number and 1^{st}/2^{nd}/3^{rd} RIDs from the temporary storage area, concatenates the read version number and RIDs, uses the read secret key (SK_CA) on the concatenated value to generate signature data, and stores the generated signature data in the temporary storage area as a CRL signature. The CA terminal then reads the 3^{rd}/4^{th}/5^{th} RIDs, concatenates the version number read previously with the read RIDs, uses the secret key (SK_CA) on the concatenated value to generate signature data, and stores the generated signature data in the temporary storage area directly following the previously stored CRL signature.

The CA terminal repeats the above operation until the signature data for the version number and the m−2^{th}/m−1^{th}/m^{th} RIDs has been generated and stored in the temporary storage area directly following the previously stored CRL signature.

The CA terminal is thus able to generate a playback device CRL.

Here, if the number of RIDs for signing with respect to the final CRL signature does not satisfy the RID signing number, the CA terminal generates a CRL signature using version number and the remaining number of RIDs, and stores the generated CRL signature in the temporary storage area.

Playback Device: Described here is an exemplary search and extraction method performed in a playback device according to the present variation. Note that CRL 1000 is recorded on a recording medium.

The playback device receives CRL 1000 via a reading device, and acquires the version number included in the received CRL.

The playback device acquires, based on the RID signing number, all of the intervals from the plurality of RIDs included in CRL 1000, arranges the acquired intervals in ascending order, and temporarily stores the arranged intervals. Here, each acquired interval consists of three RIDs. For example, if the data in CRL 1000 is as shown in FIG. 26, the intervals when enumerated in ascending order for temporary storage are “RID1˜RID2˜RID3”, “RID3˜RID4˜RID5”, “RID5˜RID6˜RID7”, and “RID7˜RID8˜RID9”.

The playback device searches for and retrieves the ID interval from the acquired intervals. The playback device retrieves the interval number showing the number of the ID interval among the intervals stored in ascending order. For example, if the extracted ID interval is “RID5˜RID6˜RID7”, the retrieved interval number will be “3”, given that the ID interval is third among the stored intervals.

The playback device extracts a CRL signature using the retrieved interval number.

Note that the extraction information outputted to the reading device by the playback device consists of the version number, an ID interval shown by three RIDs, and a CRL signature for the version number and RIDs.

Also, a “valid interval” used when judging the validity of a certificate is a range in the ID interval that excludes the RIDs included in the extraction information. For example, if the ID interval is “RID1=0000˜RID2=0003˜RID3=0010”, there will be two valid intervals, namely “1, 2” and “4, 5, 6, 7, 8, 9”.

(9) The RID signing number in variation (8) is not limited to being a fixed number. The RID signing number may be a variable number.

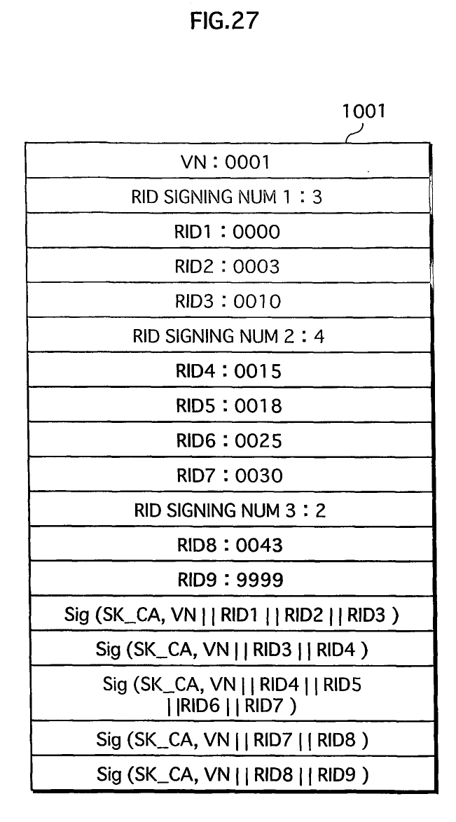

FIG. 27 shows an exemplary CRL 1001 according to this variation.

CRL 1001 is constituted from areas storing, respectively, the version number (VN) of the CRL, one or more RID signing numbers, a plurality of revoked certificate IDs (RID), and one or more signatures certifying the authenticity of the version number and RIDs. Each CRL signature is signature data generated by performing a digital signature using the secret key (SK_CA) held only by the CA. Digital signatures that use an RSA cryptosystem employing hash functions are one example.

As shown in FIG. 27, IDs “0000” and “9999” not allocated to actual certificates are also recorded in CRL 1001. The version number is a value incremented by “1” whenever CRL 1001 is updated. Each RID-signing number, which is a value greater than of equal to “2”, shows the number of RIDs to be signed together with the version number. CRL signatures are provided for values obtained by concatenating the version number with the number of RIDs shown by a RID signing number.

The data in CRL 1001, from the top down (see FIG. 27), is the version number, a RID signing number 1 and a corresponding number of RIDs, a RID signing number 2 and a corresponding number of RIDs, and so on, with the CRL signatures positioned at the bottom.

Note that the initial state of CRL 1001 is, for example, constituted from a version number “0000”, a RID signing number “2”, two RIDs “0000” and “9999”, and a single CRL signature “Sig(SK_CA,0000∥0000∥9999)”.

CA Terminal: Described below is the generation of CRL 1001 performed in a CA terminal according to the present variation. Description of the writing of CRL 1001 to a recording medium, being similar to variation (8), is omitted here.

The CA terminal prestores the secret key (SK_CA), and a pre-update CRL (i.e. CRL prior to generating CRL 1001). The CA terminal has a temporary storage area for temporarily storing CRL 1001 generated in the CA terminal, and a RID storage area for temporarily storing all of the RIDs read from the pre-update CRL.

The CA terminal, on receipt of a CRL generation instruction and the IDs of all revoked certificates from an authorized user of the CA terminal, reads all of the RIDs recorded in the pre-update CRL, uses the received IDs and read RIDs to arrange the IDs in ascending order, and stores the arranged IDs in the RID storage area.

The CA terminal acquires the version number from the pre-update CRL, adds “1” to the acquired number to update the version number, and stores the updated version number in the temporary storage area.

The CA terminal receives a RID signing number from the user, stored the received number in the temporary storage area, and reads the RIDs stored in the RID storage area, based on the RID signing number.

The CA terminal uses the secret key (SK_CA), the version number, and the plurality of RIDs to generate CRL signatures for the version number and RIDs based on received RID signing numbers, stores the generated CRL signatures in the temporary storage area, and generates a playback device CRL for recording to a recording medium.

The CA terminal, having generated and stored the CRL signatures in the temporary storage area, updates the content of the pre-update CRL to the content stored in the temporary storage area.

The following description relates to the generation of CRL signatures.

Here, the number of revoked IDs stored in the temporary storage area (i.e. the number of RIDs) is given as “m” (m≧2). The RIDs stored in the temporary storage area, in ascending order of the ID values, are referred to as the 1^{st} RID, 2^{nd} RID, . . . m^{th} RID.

The CA terminal reads the prestored secret key (SK_CA).

The CA terminal receives a RID signing number “p” from the user and stores the received number in the temporary storage area.

The CA terminal reads one more RID than the RID signing number (i.e. “p+1” RIDs) from the RID storage area, based on a reference RID (initial value=1^{st} RID).

The CA terminal concatenates the version number stored in the temporary storage area and “p” number of the read “p+1” RIDs, based on the reference RID, uses the read secret key (SK_CA) on the concatenated value to generate signature data, and stores the generated signature data in the temporary storage area as a CRL signature. The CA terminal then concatenates the version number with the p^{th} and p+1^{th} RIDs based on the reference RID, uses the secret key (SK_CA) on the concatenated value to generate signature data, and stores the generated signature data in the temporary storage area as a CRL signature. The CA terminal sets the p+1^{th} RID as the reference RID, receives a RID signing number from the user showing the number of RIDs to be signed in generating the next CRL signatures, stores the received number in the temporary storage area, and repeats the above operations.

If the CA terminal detects, upon reading the m^{th} RID from the RID storage area based on the reference RID, that read m^{th} RID is contained within the RID signing number “p” received from the user (i.e. detects that a p+1^{th} RID does not exist), the CA terminal concatenates the version number stored in the temporary storage area with the RIDs from the reference RID to the m^{th} RID, uses the secret key (SK_CA) on the concatenated value to generate signature data, and stores the generated signature data in the temporary storage area as a CRL signature.

The CA terminal is able to generate CRL 1001 as a result of the above operations.

Playback Device: Described here is an exemplary search and extraction method performed in a playback device according to the present variation. Note that CRL 1001 is recorded on a recording medium.

The playback device receives CRL 1001 via a reading device, and acquires the version number included in the received CRL.

The playback device acquires, based on the RID signing number, all of the intervals from the plurality of RIDs included in CRL 1001, arranges the acquired intervals in ascending order, and temporarily stores the arranged intervals. Each acquired interval consists of either the number of RIDs shown by a RID signing number or two RIDs on either side of a RID signing number (e.g. RID3 & RID4 in FIG. 27). For example, if the data in CRL 1001 is as shown in FIG. 27, the intervals when enumerated in ascending order for temporary storage are “RID1˜RID2˜RID3”, “RID3˜RID4”, “RID4˜RID5˜RID6˜RID7”, “RID7˜RID8”, and “RID8˜RID9”.

The playback device searches for and retrieves the ID interval from the acquired intervals. The playback device retrieves the interval number showing the number of the ID interval among the intervals stored in ascending order. For example, if the extracted ID interval is “RID4˜RID5˜RID6˜RID7”, the retrieved interval number will be “3”, given that the ID interval is third among the stored intervals.

The playback device extracts a CRL signature using the retrieved interval number.

Note that the extraction information outputted to the reading device by the playback device consists of the version number, an ID interval shown by three RIDs, and a CRL signature for the version number and RIDs.

(10) The present invention is not limited to the use of a playback device CRL when a reading device authenticates a playback device, as in embodiments 1 and 2. A list (hereinafter “mixed list”) that includes the IDs of both revoked and valid certificates may be used in the authentication process.

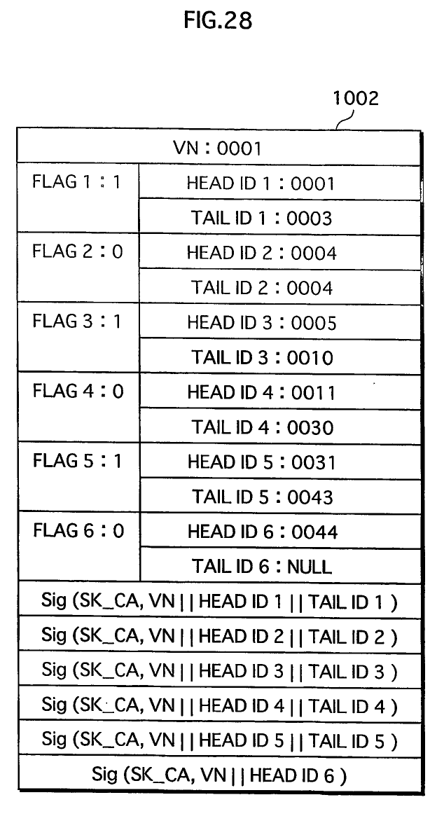

FIG. 28 shows an exemplary mixed list 1002 according to this variation.

Mixed list 1002 is constituted from areas storing, respectively, the version number (VN) of the list, one or more groups formed from a flag and two IDs (head and tail IDs), and one or more pieces of signature data. Each piece of signature data is generated by performing a digital signature using the secret key (SK_CA) held only by the CA. Digital signatures that use an RSA cryptosystem employing hash functions are one example.

The version number is a value incremented by “1” whenever mixed list 1002 is updated. A flag shows whether a certificate ID belonging to a range defined by the corresponding head and tail IDs is valid or revoked. Here, a “0” flag indicates valid and a “1” indicates revoked. A head ID is an ID defining the head of a range corresponding to a flag, and a tail ID is an ID defining the end of a range corresponding to a flag. The groups consisting of a flag and two IDs (head and tail IDs) are recorded in the list in ascending order.

Signature data is provided for values obtained by concatenating the version number with the head and tail IDs, and recording in the list in ascending order.

Note that if a range consists of only a single ID, the same ID is recorded for the head and tail IDs.

Also, if the range consists of all of the IDs from the head ID, a null value is recorded in the list, which shows that an ID is not recorded for the tail ID. In this case, signature data is provided for the version number and the head ID.

The initial state of mixed list 1002 is, for example, constituted from a version number “0000”, a group consisting of a “0” flag, a head ID “0001” a tail ID “null”, and signature data “Sig(SK_CA,0000∥0001)”. The ID showing the final ID in the list is not limited to being a null value. The final ID may, for example, be a dummy ID “9999”, or the greatest ID value among the issued certificates.

CA Terminal: Described below is the generation of mixed list 1002 performed in a CA terminal according to the present variation. Description of the writing of list 1002 to a recording medium, being similar to variation (8), is omitted here.

The CA terminal prestores the secret key (SK_CA), and stores a pre-update mixed list (i.e. list prior to generating mixed list 1002). The CA terminal has a temporary storage area for temporarily storing mixed list 1002 generated in the CA terminal.

The CA terminal receives a mixed list generation instruction and the ID ranges (i.e. pairs of head/tail IDs) of all revoked certificates from an authorized user of the CA terminal.

The CA terminal reads all of the flag/ID groups recorded in the pre-update mixed list.

The CA terminal, using the read groups having a “0” flag and the received pairs of head/tail IDs, forms groups consisting of “0” flags and corresponding ID ranges, and groups consisting of “1” flags and corresponding ID ranges. Consider an example in which the ID range of a read group having a “0” flag is “0004˜0030”, and the received head and tail IDs are respectively “0005” and “0010”. In this case, the following groups are obtained:

“0” flag/“0004” head ID/“0004” tail ID

“1” flag/“0005” head ID/“0010” tail ID

“0” flag/“0011” head ID/“0030” tail ID

The CA terminal uses the read groups having a “1” flag and the formed groups to arrange the groups in ascending order, and stores the arranged groups in the temporary storage area.

The CA terminal acquires the version number of the pre-update list, adds “1” to the acquired number to update the version number, and stores the updated version number in the temporary storage area.

The CA terminal uses the secret key (SK_CA), the version number, and respective pairs of head/tail IDs stored in the temporary storage area to generate signature data for the version number and each ID pair, stores the generated signature data in the temporary storage area, and generates a mixed list for recording to a recording medium.

The CA terminal, having generated and stored the signature data in the temporary storage area, updates the content of the pre-update list to the content stored in the temporary storage area.

Playback Device: Described here is an exemplary search and extraction method performed in a playback device according to the present variation. Note that mixed list 1002 is recorded on a recording medium.

The playback device receives mixed list 1002 via a reading device, and acquires the version number included in the received list.

The playback device acquires from the mixed list the flag/ID group showing a range that includes the ID of the certificate of the playback device, and acquires the signature data corresponding to the acquired group.

The playback device generates extraction information that consists of the acquired flag, head/tail IDs and signature data, and outputs the generated information to a reading device.

Reading Device: Described here is the signature verification, version check and certificate validity judgment performed in a reading device. Note that mixed list 1002 is recorded on a recording medium.

The reading device stores a public key corresponding to the secret key (SK_CA) used to generate signature data.

The reading device, on receipt from the playback device of extraction information formed from a flag, head/tail IDs and signature data, uses the stored CA public key to verify the certificate and the data signature included in the extraction information.

The reading device, if judged in the signature verification that the certificate and signature data are authentic, reads mixed list 1002 from the recording medium and judges whether the version number included in the read list matches the version number included in the extraction information.

If judged to match, the reading device judges whether the ID included in the certificate is valid or revoked, based on the range shown by the head/tail IDs and the value of the flag included in the extraction information.

For example, in the case of a “0” flag, a head/tail ID range of “0011˜0030” and a “0015” certificate ID, the reading device judges the ID to be valid. Alternatively, in the case of a “1” flag, a head/tail ID range of “0005˜0010” and a “0008” certificate ID, the reading device judges the ID to be revoked.

(11) The data structure of the mixed list described in variation (10) may be applied to a playback device CRL. In this case, the CRL is constituted from areas storing, respectively, the version number (VN) of the CRL, one or more groups formed from two RIDs (i.e. head and tail IDs) defining a range of revoked certificates, and one or more pieces of signature data for the one or more groups.

The data structure of the mixed list described in variation (10) may also be applied to a CVL (certificate verification list). In this case, the CVL is constituted from areas storing, respectively, the version number (VN) of the CRL, one or more groups formed from two VIDs (i.e. head and tail IDs) defining a range of valid certificates, and one or more pieces of signature data for the one or more groups.

(12) The present invention is not limited to CA terminal 10 writing a playback CRL to recording medium 100, as in embodiment 1. CA terminal 10 may generate a CRL and distribute the generated CRL to the manufacturer of recording medium 100.

The present invention is not limited to CA terminal 50 writing a playback device CRL and a reading device CRL to recording medium 500, as in embodiment 2. CA terminal 50 may generate the CRLs, and distribute the generated CRLs to the manufacturer of recording medium 500.

(13) The present invention is not limited to a playback device, on receipt of detection information from a reading device, receiving a playback device CRL via the reading device, as in embodiments 1 and 2.

For example, a playback device may receive a playback device CRL via a reading device upon being requested by the reading device for extraction information and a certificate.

Also, a reading device may read a playback device CRL from a recording medium at the start of the authentication of the playback device, output the read CRL and a request for extraction information and a certificate to the playback device, and in response, the playback device may generate extraction information and output the generated information and the certificate of the playback device to the reading device.

(14) The present invention is not limited the RIDs included in a playback device CRL being in ascending order, as in embodiments 1 and 2.

The RIDs in a CRL may be recorded in descending order. In this case, the CRL signatures are also recorded in the CRL so that the pairs of ID signed together with the version number are in descending order.

(15) The present invention is not limited to using the identifiers of certificates in judging whether a playback device is valid or revoked, as in embodiments 1 and 2. An identifier identifying the playback device may alternatively be used.

(16) IDs formed from a dummy ID and a null value are included within the concept of certificate IDs for the purposes of the present invention.

(17) The present invention is not limited to being constituted from a playback device and a reading device, as in embodiments 1 and 2. The present invention may be a single device constituted from application software and a drive unit for performing data input/output with a recording medium. In this case, the operations of the playback device and reading device may be performed by the application software and drive unit, respectively. Here, the application software includes the information (certificate, device key, secret key, CA public key, etc) held by the various storage units of the playback device in the preferred embodiments, and the drive unit judges whether the application software is valid or revoked. For example, the present invention may be a personal computer (PC) environment constituted from a drive unit of the PC and application software for operating in the PC. Alternatively, the drive unit/application software configuration may be applied in a DVD playback device or the like.

(18) The present invention is not limited to providing separate playback device and reading device CRLs, as in embodiment 2. Playback device and reading device CRLs may be provides as a single list.

(19) The present invention is not limited to using head and tail IDs to show the ranges of valid and revoked IDs, as in variation 10. The ranges may be shown using groups consisting of a head ID and a value “N” indicating the number of valid or revoked IDs from the head ID. In this case, the signature is “Sig(SK_CA,VN∥head ID∥N)”

For example, a range shown by a head ID “0003” and a tail ID “0010” according to variation 10 would, according to variation 19, be shown by a head ID “0003” and a N value

(20) The present invention may be methods for executing the above. The methods may be computer programs realized by a computer, or digital signals consisting of the computer programs.

Alternatively, the present invention may be a machine readable recording medium that stores the computer programs or digital signals, examples of which include a flexible disk, a hard disk, a CD-ROM, an MO, a DVD, DVD-ROM, a DVD-RAM, a BD (blu-ray disk), a semi-conductor memory, or the like. Also, the present invention may be the computer programs or digital signals stored on any of these recording media.

The present invention may be a mechanism for transmitting the computer programs or digital signals via a network or the like, representative examples of which include a telecommunication circuit, a wireless or cable communication circuit, and the Internet.

The present invention may be a computer system that includes a microprocessor and a memory, the memory storing the computer programs and the microprocessor operating in accordance with the computer programs.

Also, the computer programs or digital signals may be conveyed to another independent computer system either via the network or by being recorded on the recording medium, and implemented by the other computer system.

(21) The present invention may be any combination of the preferred embodiments and variations.

4. Summary

According to the present invention as described above, a playback device having a higher processing capability than a common reading device searches a CRL and outputs the search result (extraction information) and a certificate held by the playback device to the reading device, thus enabling the reading device to execute signature verification using only the received search result and certificate, without needing to search the CRL itself. This allows efficient authentication to be performed in an authentication system. Also, by performing a digital signature on ID intervals or individual IDs in a CRL for searching by a playback device, the playback device can be prevented from acting in an unauthorized manner.

When performing two-way authentication according to the present invention, the playback device, in authenticating the reading device, searches a reading device CRL (conventional CRL structure) and uses the search result in authenticating the reading device, whereas as when the reading device authenticates the playback device, the playback device searches a playback device CRL and outputs the search result (extraction information) and the certificate of the playback device to the reading device, thus enabling the reading device to execute signature verification using only the received search result and certificate. This allows efficient mutual authentication to be performed in an authentication system.

An authentication system pertaining to the present invention, which enables efficient authentication to be realized even when a reading device of low processing capacity is included in the system, is effective, for instance, in authentication systems that employ public key encryption, and particularly in authentication systems that use public key certificate revocation lists that identify revoked public key certificates.

### INDUSTRIAL APPLICABILITY

The devices and recording mediums constituting the present invention can be used administratively again and again over a long period of time in content distribution industries that create and distribute content. These devices and recording mediums can also be manufactured and retailed administratively again and again over a long period of time in electrical appliance manufacturing industries.

1. An information input/output system comprising:
an input/output device; and
an information usage device that performs information input/output via the input/output device, wherein the input/output device has the information usage device perform part of processing for judging whether the information usage device is one of valid and revoked.

2. The information input/output system of claim 1, wherein:
the input/output device outputs an identifier list to the information usage device, the identifier list including one or more identifiers, arranged according to a predetermined rule, that each correspond to a different valid or revoked device,
the information usage device, as part of the judgment processing, uses the received identifier list in specifying a target range that includes a target identifier stored by the information usage device, and outputs range information indicating the specified target range to the input/output device, and
the input/output device receives the range information from the information usage device, and uses the received range information in judging whether the information usage device is valid or revoked.

3. The information input/output system of claim 2, wherein the input/output device includes:
an acquiring unit operable to acquire the identifier list from an external source;
an output unit operable to output the acquired identifier list to the information usage device;
an ID receiving unit operable to receive from the information usage device, the target identifier and, as the range information, one or more identifiers from the identifier list that are included within the target range; and
a judging unit operable to judge whether the information usage device is valid or revoked, depending on whether the received target identifier matches any of the identifiers received as the range information, and to suppress the information input/output if the information usage device is judged to be revoked, and
the information usage device includes:
a storage unit operable to store the target identifier, which corresponds to the information usage device;
a receiving unit operable to receive the identifier list from the input/output device,
an extracting unit operable to use the received identifier list in specifying the target range, and to extract all of the identifiers included within the specified target range from the identifier list; and
a data output unit operable to output to the input/output device the target identifier and the one or more identifiers extracted as the range information.

4. The information input/output system of claim 3, wherein
the extracting unit specifies the target range from one or more ranges each defined by two identifiers arranged consecutively in the identifier list, and extracts the two identifiers defining the specified target range,
the data output unit outputs to the input/output device the target identifier and the two identifiers extracted as the range information,
the ID receiving unit receives from the information usage device the target identifier and the two identifiers extracted as the range information, and
the judging unit judges whether the information usage device is valid or revoked, depending on whether the target identifier matches either of the two extracted identifiers.

5. The information input/output system of claim 3, wherein
the target identifier identifies a public-key certificate certifying the authenticity of a public key of the information usage device,
each identifier in the identifier list identifies a public-key certificate of a different revoked device,
the extracting unit extracts in the arranged order, the one or more identifiers included within the specified target range, and
the judging unit judges the information usage device to be revoked if the target identifier matches any of the one or more extracted identifiers, and to be valid if the target identifier does not match any of the one or more extracted identifiers.

6. The information input/output system of claim 5, wherein
the identifier list has arranged therein according to the predetermined rule, certification data that certifies, with respect to each of one or more ranges, the authenticity of the one or more identifiers included within the range,
the extracting unit extracts from the identifier list, the certification data certifying the authenticity of the one or more extracted identifiers,
the data output unit outputs the extracted certification data to the input/output device,
the ID receiving unit receives the extracted certification data from the information usage device, and
the judging unit verifies the authenticity of the received certification data, and judges, if the authenticity is verified, whether the information usage device is valid or revoked.

7. The information input/output system of claim 3, wherein
the target identifier identifies a public-key certificate certifying the authenticity of a public key of the information usage device,
each identifier in the identifier list identifies a public-key certificate of a different valid device,
the extracting unit judges whether any of the identifiers in the identifier list match the target identifier, and extracts the matching identifier if judged in the affirmative, and
the judging unit judges the information usage device to be valid if the target and extracted identifiers match.

8. The information input/output system of claim 7, wherein
the identifier list has arranged therein one or more pieces of certification data, each corresponded to and certifying the authenticity of a different one of the identifiers,
the extracting unit extracts the certification data corresponding to the extracted identifier,
the data output unit outputs the extracted certification data to the input/output device,
the ID receiving unit receives the extracted certification data from the information usage device, and
the judging unit verifies the authenticity of the received certification data, and judges, if the authenticity is verified, whether the information usage device is valid or revoked.

9. The information input/output system of claim 3, wherein
the input/output device further includes:
an information output unit operable to securely output usage information to the information usage device, if the information usage device is judged to be valid, and
the information usage device further includes:
a usage unit operable to securely receive the usage information from the input/output device, and use the received usage information.

10. The information input/output system of claim 3, wherein
the input/output device further includes:
an ID storage unit operable to store a certificate identifier that identifies a public-key certificate certifying the authenticity of a public key of the input/output device; and
an ID output unit operable to output the certificate identifier to the information usage device, and
the information usage device further includes:
an ID reception unit operable to receive the certificate identifier from the input/output device;
a list receiving unit operable to receive a revocation list via the input/output device, the revocation list including one or more revoked identifiers that each identify a public-key certificate of a different revoked device; and
an ID judging unit operable to judge whether the input/output device is valid or revoked, depending on whether the received certificate identifier matches any of the revoked identifiers included in the revocation list.

11. The information input/output system of claim 10, wherein
the input/output device further includes:
a 1st processing unit operable to establish a secure communication channel between the input/output device and the information usage device, if the information usage device is judged to be valid; and
an information output unit operable to securely output usage information to the information usage device, if the secure communication channel is established, and
the information usage device further includes:
a 2nd processing unit operable to establish a secure communication channel between the information usage device and the input/output device, if the input/output device is judged to be valid; and
a usage unit operable to securely receive the usage information from the input/output device if the secure communication channel is established, and to use the received usage information.

12. The information input/output system of claim 3 further comprising a recording medium storing the identifier list, wherein
the acquiring unit acquires the identifier list from the recording medium.

13. The information input/output system of claim 3 further comprising a communication medium operable to receive the identifier list, wherein
the acquiring unit acquires the identifier list from the communication medium.

14. The information input/output system of claim 3 further comprising a list generation device that includes:
a list storage unit; and
a generating unit operable to generate the identifier list, and write the generated identifier list to the list storage unit.

15. An input/output device via which an information usage device performs information input/output, and that has the information usage device perform part of processing for judging whether the information usage device is one of valid and revoked.

16. The input/output device of claim 15 outputs an identifier list to the information usage device, the identifier list including one or more identifiers, arranged according to a predetermined rule, that each correspond to a different valid or revoked device, receives range information indicating a target range from the information usage device, the target range, which is specified using the identifier list, including a target identifier corresponding to the information usage device, and uses the received range information in judging whether the information usage device is valid or revoked.

17. The input/output device of claim 16, comprising:
an acquiring unit operable to acquire the identifier list from an external source;
an output unit operable to output the acquired identifier list to the information usage device;
an ID receiving unit operable to receive from the information usage device, the target identifier and, as the range information, one or more identifiers, extracted from the identifier list by the information usage device, that are included within the target range; and
a judging unit operable to judge whether the information usage device is valid or revoked, depending on whether the received target identifier matches any of the identifiers received as the range information, and to suppress the information input/output if the information usage device is judged to be revoked.

18. The input/output device of claim 17, wherein the target identifier identifies a public-key certificate certifying the authenticity of a public key of the information usage device,
each identifier in the identifier list identifies a public-key certificate of a different revoked device, and
the judging unit judges the information usage device to be revoked if the target identifier matches any of the one or more extracted identifiers, and to be valid if the target identifier does not match any of the one or more extracted identifiers.

19. The input/output device of claim 18, wherein
the identifier list has arranged therein according to the predetermined rule, certification data that certifies, with respect to each of one or more ranges, the authenticity of the one or more identifiers included within the range,
the ID receiving unit receives from the information usage device, certification data, extracted from the identifier list by the information usage device, that certifies the authenticity of the one or more extracted identifiers, and
the judging unit verifies the authenticity of the received certification data, and judges, if the authenticity is verified, whether the information usage device is valid or revoked.

20. The input/output device of claim 19, wherein
the extracted certification data is signature data generated by performing a digital signature on the one or more extracted identifiers, and
the judging unit stores a public key corresponding to a secret key used in generating the signature data, and uses the public key in verifying the authenticity of the signature data.

21. The input/output device of claim 19, wherein
the extracted certification data is an authenticator generated by using a 1st secret key on the one or more extracted identifiers, and
the judging unit stores a 2nd secret key that is identical to the 1st secret key, and uses the 2nd secret key in verifying the authenticity of the authenticator.

22. The input/output device of claim 17, wherein
the target identifier identifies a public-key certificate certifying the authenticity of a public key of the information usage device,
each identifier in the identifier list identifies a public-key certificate of a different valid device,
the ID receiving unit receives the target identifier and a single extracted identifier, and
the judging unit judges the information usage device to be valid if the target and extracted identifiers match, and to be revoked if the target and extracted identifiers do not match.

23. The input/output device of claim 22, wherein
the identifier list has arranged therein one or more pieces of certification data, each corresponded to and certifying the authenticity of a different one of the identifiers,
the ID receiving unit receives from the information usage device, certification data, extracted from the identifier list by the information usage device, that certifies the authenticity of the extracted identifier, and
the judging unit verifies the authenticity of the received certification data, and judges, if the authenticity is verified, whether the information usage device is valid or revoked.

24. The input/output device of claim 17, wherein
the target identifier is included in a public-key certificate certifying the authenticity of a public key of the information usage device,
each identifier in the identifier list is included in a public-key certificate of a different valid or revoked device, and
the ID receiving unit receives from the information usage device, the target identifier, and two extracted identifiers defining the target range, which is a range showing the public-key certificates of one of valid or revoked devices, and
the judging unit judges whether the information usage device is valid or revoked, depending on whether the target identifier is included within the range defined by the two extracted identifiers.

25. The input/output device of claim 17, further comprising:
an information output unit operable to securely output usage information to the information usage device, if the information usage device is judged to be valid.

26. The input/output device of claim 25, wherein
the ID receiving unit receives a public key of the information usage device, and
the information output unit uses the received public key in encrypting the usage information to generate encrypted usage information, and outputs the encrypted usage information to the information usage device.

27. The input/output device of claim 17, further comprising:
an ID storage unit operable to store a certificate identifier that identifies a public-key certificate certifying the authenticity of a public key of the input/output device; and
an ID output unit operable to output the certificate identifier to the information usage device.

28. The input/output device of claim 27, further comprising:
a processing unit operable to establish a secure communication channel between the input/output device and the information usage device, if the information usage device is judged to be valid; and
an information output unit operable to securely output usage information to the information usage device, if the secure communication channel is established.

29. The input/output device of claim 28, wherein
the processing unit judges that a secure communication channel has been established if a shared key is generated between the information usage and input/output devices, and
the information output unit encrypts the usage information using the shared key to generate encrypted usage information, and outputs the encrypted usage information to the information usage device.

30. An information usage device that performs information input/output via an input/output device, and, when instructed by the input/output device, performs part of processing for judging whether the information usage device is one of valid and revoked.

31. The information usage device of claim 30 receives an identifier list from the input/output device, the identifier list including one or more identifiers, arranged according to a predetermined rule, that each correspond to a different valid or revoked device, and, as part of the judgment processing, uses the received identifier list in specifying a target range that includes a target identifier stored by the information usage device, and outputs range information indicating the specified target range to the input/output device.

32. The information usage device of claim 31, comprising:
a storage unit operable to store the target identifier, which corresponds to the information usage device;
a receiving unit operable to receive the identifier list from the input/output device;
an extracting unit operable to use the received identifier list in specifying the target range, and to extract all of the identifiers included within the specified target range from the identifier list; and
a data output unit operable to output to the input/output device the target identifier and the one or more identifiers extracted as the range information.

33. The information usage device of claim 32, wherein
the extracting unit specifies the target range from one or more ranges each defined by two identifiers arranged consecutively in the identifier list, and extracts the two identifiers defining the specified target range, and
the data output unit outputs to the input/output device the target identifier and the two identifiers extracted as the range information.

34. The information usage device of claim 32, wherein
the target identifier identifies a public-key certificate certifying the authenticity of a public key of the information usage device,
each identifier in the identifier list identifies a public-key certificate of a different revoked device, and
the extracting unit extracts in the arranged order, the one or more identifiers included within the specified target range.

35. The information usage device of claim 34, wherein
the identifier list has arranged therein according to the predetermined rule, certification data that certifies, with respect to each of one or more ranges, the authenticity of the one or more identifiers included within the range,
the extracting unit extracts from the identifier list, the certification data certifying the authenticity of the one or more extracted identifiers, and
the data output unit outputs the extracted certification data to the input/output device.

36. The information usage device of claim 35, wherein the extracted certification data is signature data generated by performing a digital signature on the one or more extracted identifiers.

37. The information usage device of claim 35, wherein the extracted certification data is an authenticator generated by using a common secret key that is identical to a secret key of the input/output device on the one or more extracted identifiers.

38. The information usage device of claim 32, wherein
the target identifier identifies a public-key certificate certifying the authenticity of a public key of the information usage device,
each identifier in the identifier list identifies a public-key certificate of a different valid device, and
the extracting unit judges whether any of the identifiers in the identifier list match the target identifier, and extracts the matching identifier if judged in the affirmative.

39. The information usage device of claim 38, wherein
the identifier list has arranged therein one or more pieces of certification data, each corresponded to and certifying the authenticity of a different one of the identifiers,
the extracting unit extracts the certification data corresponding to the extracted identifier, and
the data output unit outputs the extracted certification data to the input/output device.

40. The information usage device of claim 32, wherein
the target identifier is included in a public-key certificate certifying the authenticity of a public key of the information usage device,
each identifier in the identifier list is included in a public-key certificate of a different valid or revoked device, and
the extracting unit specifies the target range, which is a range showing the public-key certificates of one of valid or revoked devices, and extracts the two identifiers defining the specified target range.

41. The information usage device of claim 32, further comprising:
a usage unit operable to securely receive usage information from the input/output device if judged by the input/output device that the information usage device is valid, and to use the received usage information.

42. The information usage device of claim 41, wherein
the usage information was encrypted in the input/output device using a public key of the information usage device, and
the usage unit stores a secret key corresponding to the public key, and on receipt of the encrypted usage information from the input/output device, decrypts the encrypted usage information using the secret key to generate usage information and uses the generated usage information.

43. The information usage device of claim 32, further comprising:
an ID reception unit operable to receive from the input/output device a certificate identifier that identifies a public-key certificate certifying the authenticity of a public key of the input/output device;
a list receiving unit operable to receive a revocation list via the input/output device, the revocation list including one or more revoked identifiers that each identify a public-key certificate of a different revoked device; and
an ID judging unit operable to judge whether the input/output device is valid or revoked, depending on whether the received certificate identifier matches any of the revoked identifiers included in the revocation list.

44. The information usage device of claim 43, further comprising:
a processing unit operable to establish a secure communication channel between the information usage device and the input/output device, if the input/output device is judged to be valid; and
a usage unit operable to securely receive usage information from the input/output device if the secure communication channel is established, and to use the received usage information.

45. The information usage device of claim 44, wherein
the processing unit judges that a secure communication channel has been established if a shared key is generated between the information usage and input/output devices,
the usage information was encrypted in the input/output device using the shared key, and
the usage unit, on receipt of the encrypted usage information from the input/output device, decrypts the encrypted usage information using the shared key and uses the generated usage information.

46. A list generation device for generating an identifier list that includes one or more identifiers corresponding to one or more valid or revoked devices, comprising:
a list storage unit;
an acquiring unit operable to acquire one or more identifiers; and
a generating unit operable to arrange the acquired identifiers according to a predetermined rule to generate an identifier list that includes the arranged identifiers, and to write the generated identifier list to the list storage unit.

47. The list generation device of claim 46, wherein
each identifier in the identifier list identifies a public-key certificate of a different revoked device, and
the generating unit includes:
a key storage subunit operable to store a secret key;
an arranging subunit operable to arrange the acquired identifiers according to the predetermined rule;
a data generating subunit operable to extract, in the arranged order of the identifiers, one or more identifiers constituting a range, and to use the secret key in generating certification data that certifies the authenticity of the one or more extracted identifiers;
a control subunit operable to control the data generating subunit to repeat the identifier extraction and the data generation, until the data generation has been completed for all of the identifiers; and
a list generating subunit operable, after the completion of the data generation for all of the identifiers, to generate an identifier list that includes the arranged identifiers and the generated certification data arranged according to the predetermined rule, and to write the generated identifier list to the list storage unit.

48. The list generation device of claim 46, wherein
each identifier in the identifier list identifies a public-key certificate of a different valid device, and the generating unit includes:
a key storage subunit operable to store a secret key;
a data generating subunit operable to use the secret key in performing a digital signature on each of the acquired identifiers to generate certification data certifying the authenticity of the identifier; and
a list generating unit operable to generate an identifier list in which the arranged identifiers are corresponded with respective pieces of the generated certification data, and to write the generated identifier list to the list storage unit.

49. A machine-readable recording medium comprising a list storage unit operable to store an identifier list that includes one or more identifiers, arranged according to a predetermined rule, that each correspond to a different valid or revoked device.

50. The recording medium of claim 49, wherein
each identifier in the identifier list identifies a public-key certificate of a different revoked device, and
the identifier list has arranged therein according to the predetermined rule, certification data that certifies, with respect to each of one or more ranges, the authenticity of the one or more identifiers included within the range.

51. The recording medium of claim 49, wherein
each identifier in the identifier list identifies a public-key certificate of a different valid device, and
the identifier list has arranged therein according to the predetermined rule, one or more pieces of certification data, each corresponded to and certifying the authenticity of a different one of the identifiers.

52. An identifier list that includes one or more identifiers, arranged according to a predetermined rule, that each correspond to a different valid or revoked device.

53. The identifier list of claim 52, wherein
each identifier corresponds to a revoked device, and
the identifier list has arranged therein according to the predetermined rule, certification data that certifies, with respect to each of one or more ranges, the authenticity of the one or more identifiers included within the range.

54. The identifier list of claim 52, wherein
each identifier corresponds to a valid device, and
the identifier list has arranged therein according to the predetermined rule, one or more pieces of certification data, each corresponded to and certifying the authenticity of a different one of the identifiers.

55. An information input/output system comprising:
an input/output device; and
application software for performing information input/output via the input/output device, wherein
the input/output device has the application software perform part of processing for judging whether the application software is one of valid and revoked.

56. A judging method used in an input/output device via which an information usage device performs information input/output, comprising the steps of:
outputting an identifier list to the information usage device, the identifier list including one or more identifiers, arranged according to a predetermined rule, that each correspond to a different valid or revoked device;
receiving range information from the information usage device, the range information showing a target range, specified using the identifier list, that includes a target identifier corresponding to the information usage device; and
using the received range information in judging whether the information usage device is one of valid and revoked.

57. A judging computer program used in an input/output device via which an information usage device performs information input/output, comprising the steps of:
outputting an identifier list to the information usage device, the identifier list including one or more identifiers, arranged according to a predetermined rule, that each correspond to a different valid or revoked device;
receiving range information from the information usage device, the range information showing a target range, specified using the identifier list, that includes a target identifier corresponding to the information usage device; and
using the received range information in judging whether the information usage device is one of valid and revoked.

58. A machine-readable recording medium storing a judging computer program used in an input/output device via which an information usage device performs information input/output, the computer program comprising the steps of:
outputting an identifier list to the information usage device, the identifier list including one or more identifiers, arranged according to a predetermined rule, that each correspond to a different valid or revoked device;
receiving range information from the information usage device, the range information showing a target range, specified using the identifier list, that includes a target identifier corresponding to the information usage device; and
using the received range information in judging whether the information usage device is one of valid and revoked.

59. An information-specifying method used in an information usage device that performs information input/output via an input/output device, comprising the steps of:
receiving an identifier list from the input/output device, the identifier list including one or more identifiers, arranged according to a predetermined rule, that each correspond to a different valid or revoked device;
using the received identifier list in specifying a target range that includes a target identifier stored by the information usage device; and
outputting range information that indicates the specified target range to the input/output device.

60. An information-specifying computer program used in an information usage device that performs information input/output via an input/output device, comprising the steps of:
receiving an identifier list from the input/output device, the identifier list including one or more identifiers, arranged according to a predetermined rule, that each correspond to a different valid or revoked device;
using the received identifier list in specifying a target range that includes a target identifier stored by the information usage device; and
outputting range information that indicates the specified target range to the input/output device.

61. A machine-readable recording medium storing an information-specifying computer program used in an information usage device that performs information input/output via an input/output device, the computer program comprising the steps of:
receiving an identifier list from the input/output device, the identifier list including one or more identifiers, arranged according to a predetermined rule, that each correspond to a different valid or revoked device;
using the received identifier list in specifying a target range that includes a target identifier stored by the information usage device; and
outputting range information that indicates the specified target range to the input/output device.
